(19) United States
(12) Patent Application Publication
(10) Pub. No.: US 2014/0278613 A1
(43) Pub. Date: Sep. 18, 2014

(54) INFORMATION PROCESSING APPARATUS, INFORMATION PROCESSING METHOD, AND INFORMATION PROCESSING PROGRAM

(71) Applicant: Rakuten, Inc., Shinagawa-ku, Tokyo (JP)

(72) Inventors: Yuji Suzuki, Shinagawa-ku (JP); Takao Oyobe, Shinagawa-ku (JP); Satoko Otani, Shinagawa-ku (JP); Takaaki Koshinuma, Shinagawa-ku (JP); Katsuyuki Masubuchi, Shinagawa-ku (JP)

(73) Assignee: RAKUTEN, INC., Shinagawa-ku, Tokyo (JP)

(21) Appl. No.: 14/351,932

(22) PCT Filed: Apr. 9, 2013
(86) PCT No.: PCT/JP2013/060683

§ 371 Date: Apr. 15, 2014

(30) Foreign Application Priority Data
Sep. 28, 2012 (JP) 2012-217757

(51) Int. Cl. G06Q 10/02

(52) U.S. Cl. CPC G06Q 10/02
USPC 705/5

(57) ABSTRACT

Vacancy information indicating the number of vacancies which is counted in units of using-persons in a facility that is occupied by persons who use an establishment is stored in a vacancy information storage unit. An information processing apparatus acquires the number of using-persons which is specified by a user. The information processing apparatus searches, on the basis of the vacancy information stored in the vacancy information storage unit, for establishments that can be used by persons of which the number is acquired. At this time, the information processing apparatus includes an establishment, in establishments that can be used, where the degree by which the number of using-persons exceeds the number of vacancies indicated by the vacancy information is smaller than or equal to a reference value. The information processing apparatus causes the found establishments to be presented.

### TECHNICAL FIELD

The present invention relates to a technical field of an information processing apparatus and an information processing method which search for available establishments.

### BACKGROUND ART

Conventionally, a system is known in which the numbers of vacant seats in restaurants are stored in a database and presents, to a user, information of a restaurant where the number of vacant seats is larger than or equal to the number of persons which is inputted as a search condition (for example, see Patent Document 1).

### CITATION LIST

### Patent Document

Patent Document 1: JP 2003-76902 A

### SUMMARY OF INVENTION

### Technical Problem

By the way, in practice, there is a case in which three people sit down on seats for two people by squeezing together on a sofa. However, the aforementioned conventional system does not consider such a case at all, so that it is not possible to present information of a restaurant where the number of vacant seats is smaller than the number of persons which is inputted as a search condition to a user.

The present invention is made in view of the above situation, and an object of the present invention is to provide an information processing apparatus, an information processing method, and an information processing program, which can present a establishment that is not conventionally presented due to a relationship between the number of persons which is specified by a user and the number of vacancies which is counted in units of using-persons in a facility even though the establishment can be used really by persons of which the number is specified by the user.

### Solution to Problem

In order to solve the above problem, the invention according to claim 1 is an information processing apparatus comprising: a person number acquisition means that acquires a number of using-persons which is specified by a user; a search means that, on the basis of vacancy information stored in a vacancy information storage means that stores the vacancy information indicating a number of vacancies in facilities which are occupied by persons who use an establishment, searches for establishments which can be used by persons of which the number is acquired by the person number acquisition means, the number of vacancies being counted in units of using-persons, the search means including an establishment, in the establishments which can be used, where a degree by which the number of using-persons exceeds the number of vacancies indicated by the vacancy information is smaller than or equal to a reference value; and a presentation control means that causes the establishments found by the search means to be presented.

According to the invention, even when the number of vacancies which is counted in units of using-persons in the facility is smaller than the number of persons, an establishment where the degree by which the number of persons exceeds the number of vacancies is smaller than or equal to a reference value are searched for as an establishment that can be used. Therefore, it is possible to present an establishment which are not conventionally presented due to a relationship between the number of persons which is specified by a user and the number of vacancies which is counted in units of using-persons in a facility even though the establishment really can be used by persons of which the number is specified by the user.

The invention according to claim 2 is the information processing apparatus according to claim 1, further comprising: a privilege determination means that determines a privilege to be given to the user on condition that an intention is confirmed, the intention being that a group of the user uses an establishment where the number of vacancies indicated by the vacancy information is smaller than the number of using-persons which is acquired by the person number acquisition means among the establishments found by the search means and a number of persons of the group is the number of using-persons.

According to the invention, a privilege is given to the user when an intention of the user to use an establishment where the number of vacancies which is counted in units of using-persons in a facility is smaller than the number of persons which is specified by the user is confirmed. Therefore, it is possible to prompt the user to decide that persons who are more than vacancies in units of using-persons in facilities use an establishment.

The invention according to claim 3 is the information processing apparatus according to claim 2, wherein the larger the number of using-persons, the higher the privilege determination means raises a value of the privilege to be given.

According to the invention, it is possible to further prompt the user to decide that persons who are more than vacancies in units of using-persons in facilities use an establishment.

The invention according to claim 4 is the information processing apparatus according to any one of claims 1 to 3, further comprising: an acceptable person number acquisition means that acquires, from an acceptable person number storage means that stores an acceptable number of persons larger than the number of vacancies which is indicated by the vacancy information, the acceptable number of persons for the number of vacancies which is indicated by the vacancy information, of an establishment, stored in the vacancy information storage means, the acceptable number of persons having been specified by the establishment, wherein the search means searches for establishments where the acceptable number of persons which is acquired by the acceptable person number acquisition means is larger than or equal to the number of using-persons.

According to the invention, an establishment can specify how much larger the acceptable number of persons is than the number of vacancies. Therefore, it is possible to perform a search suitable for the establishment.

The invention according to claim 5 is the information processing apparatus according to any one of claims 1 to 3, further comprising: an estimation means that estimates the reference value on the basis of a reservation history of an establishment, the reservation history including a number of persons who used the establishment and a number of vacancies in the facilities which were used, the number of vacancies in the facilities which were used being counted in units of using-persons and smaller than the number of persons, wherein the search means includes an establishment, in the establishments which can be used, where the degree by which the number of using-persons exceeds the number of vacancies which is indicated by the vacancy information is smaller than or equal to the reference value estimated by the estimation means.

According to the invention, the reference value is estimated based on the reservation history and establishments are searched for based on the estimated reference value. Therefore, it is possible for the establishment and the user to save time and effort to specify a degree of allowance.

The invention according to claim 6 is the information processing apparatus according to any one of claims 1 to 5, further comprising: an establishment-specified search method acquisition means that acquires an establishment-specified search method specified by an establishment as a method in which the establishment is searched for, the establishment-specified search method including at least one of a first method which searches for establishments where the number of vacancies which is counted in units of using-persons in facilities which are occupied by persons who use the establishment is larger than or equal to the number of using-persons, and a second method which searches for establishments where the number of vacancies which is counted in units of using-persons in facilities which are occupied by persons who use the establishment is smaller than the number of using-persons and a degree by which the number of using-persons exceeds the number of vacancies indicated by the vacancy information is smaller than or equal to the reference value, wherein the search means searches for establishments by using at least one of the first and the second methods and searches for establishments whose search methods acquired by the establishment-specified search method acquisition means corresponds to the search method used by the search means.

According to the invention, in a relationship between the number of vacancies and the number of persons, the establishment can specify a search method by which a search for the establishment is allowed. Therefore, it is possible to perform a search considering the circumstances of the establishment.

The invention according to claim 7 is the information processing apparatus according to any one of claims 1 to 6, further comprising: a user-specified search method acquisition means that acquires a user-specified search method specified by the user, the user-specified search method including at least one of a method which searches for establishments where the number of vacancies which is counted in units of using-persons in facilities which are occupied by persons who use the establishment is larger than or equal to the number of using-persons, and a method which searches for establishments where the number of vacancies which is counted in units of using-persons in facilities which are occupied by persons who use the establishment is smaller than the number of using-persons and a degree by which the number of using-persons exceeds the number of vacancies indicated by the vacancy information is smaller than or equal to a reference value, wherein the search means searches for establishments by using the user-specified search method acquired by the user-specified search method acquisition means.

According to the invention, in a relationship between the number of vacancies and the number of persons, the user can specify a search method of establishments. Therefore, it is possible to perform a search considering the circumstances of the user.

The invention according to claim 8 is the information processing apparatus according to claim 2 or 3, wherein the privilege determination means determines the value of the privilege, which is to be given to the user, at a time when an establishment is found by the search means, and the information processing apparatus further includes a first value presentation control means that causes the value determined by the privilege determination means to be presented, a position acquisition means that acquires a position of the user, a value control means that, when it is determined on the basis of the position acquired by the position acquisition means that the user moves farther away from the establishment found by the search means, raises the value of the privilege determined by the privilege determination means, and a second value presentation control means that causes the value of the privilege which has been raised by the value control means to be presented.

According to the invention, when an establishment is found, the value of the privilege is determined and the determined value is presented. Thereafter, if the user moves farther away from the found establishment, the value of the privilege which is once determined rises and the value after the rise is presented. Therefore, the value of the privilege rises when user does not intend to use the found establishment and the user moves farther away from the establishment, so that it is possible to prompt the user to change his or her mind and use the establishment.

The invention according to claim 9 is an information processing method performed by a computer, the method comprising: a person number acquisition step of acquiring a number of using-persons which is specified by a user; a search step of, on the basis of vacancy information stored in a vacancy information storage means that stores the vacancy information indicating a number of vacancies in facilities which are occupied by persons who use an establishment, searching for establishments which can be used by persons of which the number is acquired in the person number acquisition step and including an establishment, in the establishments which can be used, where a degree by which the number of using-persons exceeds the number of vacancies indicated by the vacancy information is smaller than or equal to a reference value, the number of vacancies being counted in units of using-persons; and a presentation control step of causing the establishments found in the search step to be presented.

The invention according to claim 10 is an information processing program that causes a computer to function as: a person number acquisition means that acquires a number of using-persons which is specified by a user; a search means that, on the basis of vacancy information stored in a vacancy information storage means that stores the vacancy information indicating a number of vacancies in facilities which are occupied by persons who use an establishment, searches for establishments which can be used by persons of which the number is acquired by the person number acquisition means, the number of vacancies being counted in units of using-persons, the search means including an establishment, in the establishments which can be used, where a degree by which the number of using-persons exceeds the number of vacancies indicated by the vacancy information is smaller than or equal to a reference value; and a presentation control means that causes the establishments found by the search means to be presented.

### Advantageous Effect of Invention

According to the present invention, even when the number of vacancies which is counted in units of using-persons in the facility is smaller than the number of persons, an establishment where the degree by which the number of persons exceeds the number of vacancies is smaller than or equal to a reference value are searched for as an establishment that can be used. Therefore, it is possible to present an establishment which are not conventionally presented due to a relationship between the number of persons which is specified by a user and the number of vacancies which is counted in units of using-persons in a facility even though the establishment really can be used by persons of which the number is specified by the user.

### BRIEF DESCRIPTION OF DRAWINGS

FIG. 1 is a diagram showing an example of a schematic configuration of an information processing system S according to an embodiment.

FIGS. 2A to 2C are diagrams each showing an example of a table T and surroundings of the table T.

FIG. 3 is a block diagram showing an example of a schematic configuration of a restaurant search server 1 according to an embodiment.

FIG. 4A is a diagram showing an example of content registered in a member information DB 12a. FIG. 4B is a diagram showing an example of content registered in a restaurant information DB 12b. FIG. 4C is a diagram showing an example of content stored in seat information. FIG. 4D is a diagram showing an example of content registered in a vacant seat information DB 12c. FIG. 4E is a diagram showing an example of content registered in a reservation information DB 12d.

FIG. 5 is a diagram showing an example of functional blocks of the restaurant search server 1 according to an embodiment.

FIG. 6 is a sequence diagram showing a process overview of an information processing system S according to an embodiment.

FIG. 7A is a diagram showing a display example of a top page. FIG. 7B is a diagram showing a display example of a search method selection list box 104.

FIGS. 8A and 8B are diagrams each showing a display example of a search result page.

FIG. 9 is a diagram showing a display example of a reservation completion page.

FIG. 10 is a flowchart showing an example of a search process of a system control unit 14 of the restaurant search server 1 according to an embodiment.

FIG. 11 is a flowchart showing an example of a point calculation process of the system control unit 14 of the restaurant search server 1 according to the present invention.

FIG. 12 is a diagram showing a display example of a top page.

FIG. 13 is a flowchart showing an example of a search process of a system control unit 14 of a restaurant search server 1 according to an embodiment.

FIG. 14A is a block diagram showing an example of a schematic configuration of a restaurant search server 1 according to an embodiment. FIG. 14B is a diagram showing an example of content registered in an acceptable person number DB 12e.

FIG. 15 is a diagram showing an example of functional blocks of the restaurant search server 1 according to an embodiment.

FIG. 16 is a flowchart showing an example of an acceptable person number estimation process of the restaurant search server 1 according to an embodiment.

FIG. 17 is a flowchart showing an example of a search process of a system control unit 14 of the restaurant search server 1 according to an embodiment.

FIG. 18 is a diagram showing a process in which the number of points to be acquired increases by movement of a user.

FIG. 19 is a flowchart showing an example of a restaurant information transmission process of a system control unit 14 of a restaurant search server 1 according to an embodiment.

FIG. 20 is a flowchart showing an example of a point control process of the system control unit 14 of the restaurant search server 1 according to an embodiment.

### DESCRIPTION OF EMBODIMENTS

Hereinafter, embodiments of the present invention will be described in detail with reference to the drawings. The embodiments described below are embodiments where the present invention is applied to an information processing system.

### 1. First Embodiment

### 1-1. Schematic Configuration and Function of Information Processing System

First, a configuration of an information processing system S according to the present embodiment will be described with reference to FIG. 1. FIG. 1 is a diagram showing an example of a schematic configuration of the information processing system S according to the present embodiment.

As shown in FIG. 1, the information processing system S includes a restaurant search server 1, a plurality of restaurant terminals 2, and a plurality of user terminals 3. The restaurant search server 1, each restaurant terminal 2, and each user terminal 3 can transmit and receive data to and from each other through a network NW by using, for example, TCP/IP as a communication protocol. The network NW includes, for example, the Internet, a dedicated communication line (for example, a CATV (Community Antenna Television) line), a mobile communication network (including a base station and the like), and a gateway.

The restaurant search server 1 is a server device that performs various processes related to a restaurant search site for searching for a restaurant. The restaurant search server 1 is an example of an information processing apparatus of the present invention. The restaurant is an example of an establishment of the present invention. A user can search for a desired restaurant from a plurality of restaurants by using the restaurant search site. Further, the user can reserve a restaurant by using the restaurant search site. The restaurant search server 1 transmits a web page of the restaurant search site in response to a request from the restaurant terminal 2 or the user terminal 3. The restaurant search server 1 performs processes such as registration of vacant seat information of a restaurant, search for a restaurant, reservation of a restaurant, and the like.

The restaurant terminal 2 is a terminal device used by a dish provider who provides a dish in a restaurant. For example, the dish provider is an owner, an employee, and the like of the restaurant. The provision of a dish is an example of a service. The restaurant terminal 2 receives a web page from the restaurant search server 1 and displays the web page by accessing the restaurant search server 1 on the basis of an operation from the dish provider. For example, the dish provider registers current vacant seat information of the restaurant in the restaurant search site by using the restaurant terminal 2. In the restaurant terminal 2, software such as a browser and an email client is installed. For example, a personal computer is used as the restaurant terminal 2.

The user terminal 3 is a terminal device of a user who uses the restaurant search site. The user terminal 3 receives a web page from the restaurant search server 1 and displays the web page by accessing the restaurant search server 1 on the basis of an operation from the user. In the user terminal 3, software such as a browser and an email client is installed. For example, a personal computer, a PDA (Personal Digital Assistant), a mobile information terminal such as a smartphone, and a mobile phone are used as the user terminal 3.

### 1-2. Search for Restaurants Based on the Number of Vacant Seats and the Number of Persons

Next, search for restaurants will be described with reference to FIG. 2. The restaurant search server 1 manages the number of vacant seats of restaurants. Specifically, the restaurant search server 1 receives vacant seat information transmitted from the restaurant terminal 2 and registers the vacant seat information in a vacant seat information DB 12c described later. The vacant seat information is information indicating the number of vacant seats. The vacant seat information is an example of vacancy information of the present invention. The restaurant search server 1 receives the number of using-persons as one of search conditions for searching for restaurants from the user terminal 3. The number of using-persons is the number of persons who use the restaurant. The restaurant search server 1 searches for available restaurants on the basis of the number of vacant seats indicated by the vacant seat information and the number of using-persons who use the restaurant. The available restaurants are, for example, restaurants that have vacant seats on which persons of which the number is specified as a search condition can sit. In general thinking, only restaurants that have vacant seats of which the number is larger than or equal to the number of using-persons are the available restaurants. However, the restaurant search server 1 searches for restaurants that can be used even if the number of vacant seats is smaller than the number of using-persons.

FIGS. 2A to 2C are diagrams each showing an example of a table T and surroundings of the table T. The table and seats placed around the table are an example of a place which customers use for receiving service of dishes in the restaurant. Such a place may be, for example, counter seats and a private room. As shown in FIG. 2A, a certain table T is placed in a certain restaurant. Chairs C1 and C2 and a sofa F are arranged around the table T. Each of the chairs C1 and C2 is a chair for one person. The sofa F is a chair for two persons. Therefore, the number of seats at the table T is four. Thus, normally, it is determined that up to four people can sit. In the example of FIG. 2A, customers P1 to P4 sit. In this case, a fixed seating capacity of the table T is four. The fixed seating capacity is, for example, the number of persons determined by the dish provider of the restaurant and is a standard value of the maximum number of customers who can sit. The fixed seating capacity is determined for each table or for each type of table. When the table T is vacant, the number of vacant seats is four. The number of vacancies is used to calculate the number of vacant seats. When the chair C1 is vacant, the number of vacancies counted in units of using-persons in the chair C1 is one. When the sofa F is vacant, the number of vacancies counted in units of using-persons in the sofa F is two. The number of vacancies counted in units of using-persons in chairs is the number of vacant seats. The chairs are examples of facilities occupied by users of the establishment in the present invention.

A difference of FIG. 2B from FIG. 2A is that three customers P3 to P5 sit on the sofa F. In other words, three people sit on seats for two people. Therefore, five people sit even though the fixed seating capacity is four. Although the customer P3 to P5 who sit on the sofa F may feel cramped, the customer P1 to P5 can use the restaurant.

A difference of FIG. 2C from FIG. 2A is that chairs C3 and C4 are arranged. Each of the chairs C1 and C2 is a chair for one person. For example, the dish provider temporarily arranges the chairs C3 and C4 according to a request of the customer P1. In this case, the number of seats temporarily increases to six. Therefore, six customers P1 to P6 can sit. Even in this case, the fixed seating capacity is four. The distances between the seats decrease, so that the customers P1 to P6 may feel cramped. However, the customers P1 to P6 can use the restaurant.

Further, seven customers can sit by combining the example of FIG. 2B and the example of FIG. 2C. Whether or not sitting ways as shown in FIGS. 2B and 2C are allowed is different depending on the restaurant or depending on the table. Further, whether or not sitting ways as shown in FIGS. 2B and 2C are allowed may be different depending on the users. An acceptable number of customers, by which the actual number of customers is larger than the number of seats, may be different depending on the restaurant. An acceptable number of seats, by which the actual number of seats is smaller than the number of using-persons, may be different depending on the users. The restaurant search server 1 searches for restaurants where use of table is allowed even when the number of vacant seats is smaller than the number of using-persons because the seating ways as shown in FIGS. 2B and 2C are allowed. As cases in which the use of table is allowed, there are a case in which the use of table is allowed by the dish provider and a case in which the use of table is allowed by the user.

The restaurant search server 1 searches for restaurants assuming that available restaurants where a degree by which the number of using-persons exceeds the number of vacant seats is smaller than or equal to a reference value are included in available restaurants. If the degree is smaller than or equal to the reference value, the use of table is allowed. In the present embodiment, the dish provider of the restaurant can register an acceptable number of persons in the restaurant search site. The acceptable number of persons is a maximum number of persons who can sit with respect to the number of seats (the fixed seating capacity) of the table. The acceptable number of persons is larger than the number of seats. The restaurant search server 1 searches for restaurants where the acceptable number of persons of a vacant table is larger than or equal to the number of using-persons specified by a user. Thereby, the user can easily find an available restaurant. Further, a chance to provide dishes is given to a restaurant in a case in which the restaurant cannot originally provide dishes. The dish provider may be able to register, for example, a ratio of the acceptable number of persons to the number of seats as a scale factor or a difference between the acceptable number of persons and the number of seats, instead of the acceptable number of persons. In this case, the scale factor or the difference may be registered for each number of seats, or one scale factor or difference may be registered for one restaurant. For example, the restaurant search server 1 may search for restaurants where a number obtained by multiplying the number of vacant seats by the registered scale factor is larger than or equal to the number of using-persons or may search for restaurants where a number obtained by subtracting the registered difference from the number of using-persons is smaller than or equal to the number of vacant seats. Each of the acceptable number of persons, the scale factor, and the difference is an example of the reference value of the present invention.

Searching for available restaurants regardless of whether or not the number of vacant seats is larger than or equal to the number of using-persons is referred to as a “flexible search”. Searching for only restaurants where the number of vacant seats is larger than or equal to the number of using-persons is referred to as a “strict search”. Searching for only restaurants where the number of vacant seats is smaller than the number of using-persons and the degree by which the number of using-persons exceeds the number of vacant seats is smaller than or equal to the reference value is referred to as a “crampedness search”. Performing the flexible search is equal to performing both the strict search and the crampedness search. For example, in a certain restaurant, it is assumed that there is a table where the number of seats is six and the acceptable number of persons is eight. If the table is vacant, the number of vacant seats is six. In the flexible search, when the number of using-persons is smaller than or equal to eight, the restaurant is found. In the strict search, when the number of using-persons is smaller than or equal to six, the restaurant is found. In the crampedness search, when the number of using-persons is seven or eight, the restaurant is found.

There is a case in which other customers sit on some of seats of the table or some of the seats are already reserved. In this case, it is optional for the dish provider of the restaurant whether or not to allow the number of the remaining vacant seats to be registered in the restaurant search site. In other words, it is optional whether or not to allow a table to be shared. For example, whether or not to allow a table to be shared may be determined in advance in the restaurant search site or may be able to be selected by the dish provider. When allowing a table to be shared, the restaurant search server 1 may determine the acceptable number of persons according to a ratio of the acceptable number of persons to the number of seats. For example, it is assumed that two seats are already reserved at a table where the number of seats is six and the acceptable number of persons is nine. In this case, the number of vacant seats is four. Since the ratio of the acceptable number of persons to the number of seats is three-seconds, the acceptable number of persons is six.

There may be a plurality of vacant tables in a restaurant. At this time, there are a way of thinking to perform a search assuming that a group of users do not allow a dish provider to have the group sit separately at the plurality of tables and a way of thinking to perform a search assuming that the group of users allow the dish provider to have the group sit separately at the plurality of tables. The former way of thinking is referred to as division-is-not-allowed-oriented thinking. The latter way of thinking is referred to as division-is-allowed-oriented thinking. When two tables, each of which has four seats, are vacant, the number of vacant seats of each table is four. It is assumed that the acceptable number of persons of each table is five. On the other hand, the number of vacant seats in the entire restaurant is eight. The acceptable number of persons in the entire restaurant is 10. In the division-is-not-allowed-oriented thinking, in the case of the strict search, the number of vacant seats (four) and the number of using-persons (six) are compared. In the case of the crampedness search, the acceptable number of persons (five) and the number of using-persons (six) are compared. Therefore, in the division-is-not-allowed-oriented thinking, the restaurant is not found. In the division-is-allowed-oriented thinking, in the case of the strict search, the number of vacant seats (eight) and the number of using-persons (six) are compared. Therefore, in the division-is-allowed-oriented thinking, the restaurant is found by the strict search or the flexible search. For example, which thinking is used to perform search may be determined in advance in the information processing system S. Or, for example, which thinking is used to perform search may be able to be specified by a user when the user specifies a search condition. For example, the restaurant search server 1 may perform search by the division-is-allowed-oriented thinking when a plurality of tables adjacent to each other are vacant and may perform search by the division-is-not-allowed-oriented thinking when a plurality of tables away from each other are vacant. The reason of this is that users may think that they do not mind sitting separately at tables if the tables are adjacent to each other.

The restaurant search server 1 may determine to give a privilege to the user and determine the privilege to be given on condition that a user's intention is confirmed. The intention for which the privilege is given is that a use's group uses, among restaurants found by the crampedness search or restaurants found by the flexible search, a restaurant where the number of vacant seats is smaller than the number of using-persons and where the degree by which the number of using-persons exceeds the number of vacant seats is smaller than or equal to the reference value and the number of members of the user's group using the restaurant is the number of using-persons which has been specified in the search condition. For example, the privilege has meaning of gratitude to the user whose group uses, by members of the group sitting tightly, the restaurant where the number of the members is larger than the number of seats.

Examples of the privilege include points, a discount on a restaurant bill, electronic money, money, and a gift. For example, the points have the same value as money in the restaurant search site and other web sites and the points can be used as money to purchase items for sale and services. In the case of the discount on a restaurant bill, for example, a discount coupon is displayed on a screen of the user terminal 3. For example, the discount coupon can be used in only the restaurants found by the flexible search or the crampedness search or can be used in only the restaurants reserved in the restaurant search site. Further, for example, the discount coupon can only be used in a restaurant when the number of members of a user's group using the restaurant is the number of persons which has been specified in the search condition. In the present embodiment, the points are given as an example of the privilege.

The larger the number of using-persons, the higher the restaurant search server 1 may determine the value of the privilege. This is because the larger the number of using-persons, the higher the probability that the profit of the restaurant increases. At this time, for example, the restaurant search server 1 may determine the value of the privilege according to the number of using-persons. Or, the restaurant search server 1 may determine the value of the privilege according to a difference between the number of using-persons and the number of vacant seats. Or, the restaurant search server 1 may determine the value of the privilege according to a ratio of the number of using-persons to the number of vacant seats.

Or, the longer the distance from the user terminal 3 when a user operates the user terminal 3 and requests a search for restaurants to the restaurant, the higher the restaurant search server 1 may determine the value of the privilege. When the user terminal 3 has a current position measuring function that uses GPS (Global Positioning System) or the like, the restaurant search server 1 can acquire the current position from the user terminal 3. When the user terminal 3 does not have the current position measuring function, the restaurant search server 1 may use an address of the user, which is registered in advance, instead of the position of the user terminal 3. The restaurant search server 1 may determine to provide a predetermined value of the privilege regardless of the number of using-persons and the distance.

The restaurant search server 1 may use a condition that the user reserves a restaurant in the restaurant search site as a condition that the intention to use the restaurant is confirmed. Or, the restaurant search server 1 may use a condition that a group of the user actually goes to use the restaurant. In any case, it is possible to confirm the intention to use the restaurant. The restaurant search server 1 may use a condition that the user reserves the restaurant and goes to use the restaurant. In the present embodiment, as an example, the restaurant search server 1 uses a condition that the user reserves the restaurant and goes to use the restaurant.

Various methods can be considered as a method to confirm that a group of the user actually goes to use the restaurant. For example, the user operates the user terminal 3 and displays, from a search result of restaurants, a restaurant page of a restaurant which the user uses. The restaurant page is a web page on which information of the restaurant is displayed. At this time, on the restaurant page, the number of using-persons which has been specified by the user, information of vacant tables (the number of vacant seats and the like), and the like are displayed. The user prints the restaurant page on paper and shows the paper to the dish provider of the restaurant. Or, when the user terminal 3 is a mobile device such as a smartphone and a mobile phone, the user shows a screen of the mobile device to the dish provider while the restaurant page is displayed on the screen of the mobile device. For example, when the number of using-persons displayed on the restaurant page is the same as the number of members of a group of the user who actually come to the restaurant and the number of vacant seats displayed on the restaurant page is the same as the number of seats at an actually vacant table, the dish provider determines that the privilege may be given. The dish provider may give the privilege to the user on the spot. For example, the dish provider discounts the restaurant bill or gives a gift. If a process of the restaurant search server 1 is required to give the privilege, for example, the dish provider inputs visit information related to the user who comes to the restaurant in the restaurant terminal 2. The visit information includes information such as information for identifying the user and information for identifying the restaurant. For example, the restaurant search server 1 performs a process to give the privilege including points or the like to the user on the basis of the visit information. Or, a one-dimensional code or a two-dimensional code which represent the visit information may be displayed on the restaurant page. The dish provider reads the visit information from the restaurant page by using a code reading device. Or, when a credit card of the user is registered in the restaurant search site, the user may use the credit card to pay the restaurant bill. The dish provider inputs information of the credit card as identification information of the user by using a card reading device or the like. The restaurant terminal 2 transmits the visit information including the information of the credit card to the restaurant search server 1. Or, when the user terminal 3 can acquire the current position by using GPS or the like, the user terminal 3 may periodically transmit the current position to the restaurant search server 1. When the position of the user terminal 3 overlaps the position of the restaurant, the restaurant search server 1 may determine that a group of the user actually goes to use the restaurant.

When the user reserves or uses a restaurant where the number of vacant seats is larger than or equal to the number of using-persons, it is optional whether or not to give the privilege to the user. If the privilege is given, for example, the restaurant search server 1 may set a value of the privilege for a restaurant where the number of vacant seats is larger than or equal to the number of using-persons to be lower than a value of the privilege for a restaurant where the number of vacant seats is smaller than the number of using-persons and the degree by which the number of using-persons exceeds the number of vacant seats is smaller than or equal to the reference value.

### 1-3. Configuration of Restaurant Search Server

Next, a configuration of the restaurant search server 1 will be described with reference to FIGS. 3 to 5.

FIG. 3 is a block diagram showing an example of a schematic configuration of the restaurant search server 1 according to the present embodiment. As shown in FIG. 3, the restaurant search server 1 includes a communication unit 11, a storage unit 12, an input/output interface 13, and a system control unit 14. The system control unit 14 and the input/output interface 13 are connected through a system bus 15.

The communication unit 11 connects to the network NW and controls communication state with the user terminal 3 and the like.

The storage unit 12 includes, for example, a hard disk drive and the like. The storage unit 12 is an example of a vacancy information storage means and an acceptable person number storage means. In the storage unit 12, databases such as a member information DB 12a, a restaurant information DB 12b, a vacant seat information DB 12c, and a reservation information DB 12d are constructed. The “DB” is an abbreviation of database.

FIG. 4A is a diagram showing an example of content registered in the member information DB 12a. In the member information DB 12a, user information related to users who use the restaurant search site is registered. Specifically, in the member information DB 12a, user attributes such as a user ID, a password, a nickname, a name, a date of birth, a gender, a postal code, an address, a phone number, an email address, credit card information, and the number of held points are registered in association with each other for each user. The user ID is identification information of the user. The number of held points is the number of points held by the user.

FIG. 4B is a diagram showing an example of content registered in the restaurant information DB 12b. In the restaurant information DB 12b, restaurant information related to restaurants is registered. The restaurant information is information registered by a dish provider of a restaurant. Specifically, in the restaurant information DB 12b, a restaurant ID, a category ID, a restaurant name, a postal code, an address, a phone number, a facsimile number, an email address, explanation of the restaurant, seat information, a flexible search permission flag, and the like are registered in association with each other for each restaurant. The restaurant ID is identification information of the restaurant. The category ID is identification information of the category of dishes provided in the restaurant.

FIG. 4C is a diagram showing an example of content stored in the seat information. The seat information is information related to seats in the restaurant. The seat information is registered for each type of table. Specifically, in the seat information, a table type ID, a table name, the number of seats, and the acceptable number of persons, and the like are stored in association with each other. The table type ID is identification information indicating a type of the table. As the type of table, for example, there are a table with four seats, a table with six seats, and the like. The dish provider can freely assign the type of table. For example, the dish provider may assign different types to a table with the same number of seats. Further, the dish provider may assign a different type to each table. As the table name, for example, there are a “table with four seats”, a “table with six seats”, and the like. The number of seats is a fixed seating capacity of a table of a type indicated by the table type ID. The acceptable number of persons is the number of persons allowed to sit at a table of a type indicated by the table type ID.

The flexible search permission flag indicates a search method which the dish provider of the restaurant selects as a condition for searching for the restaurant of the dish provider. Specifically, the flexible search permission flag is information indicating whether or not the dish provider allows search using the flexible search for the restaurant of the dish provider. When the flexible search permission flag is set to TRUE, any of the strict search, the crampedness search, and the flexible search is allowed. When the flexible search permission flag is set to FALSE, only the strict search is allowed. The dish provider can perform selection according to a policy of the restaurant or circumstances of the restaurant such as the restaurant cannot accept a reservation that exceeds the number of seats because the amount of foodstuffs is small. An initial value of the flexible search permission flag may be TRUE or FALSE. The dish provider may be able to set so that only the search by the crampedness search is allowed. The dish provider need not be able to select the search method. For example, the restaurant search server 1 may determine that all restaurants are searched for by the flexible search and the crampedness search. A crampedness search permission flag may be registered in the seat information. The crampedness search permission flag is information indicating whether or not the dish provider allows search using the crampedness search for the restaurant of the dish provider.

FIG. 4D is a diagram showing an example of content registered in the vacant seat information DB 12c. In the vacant seat information DB 12c, vacant seat information is registered. The vacant seat information is an example of vacancy information of the present invention. Specifically, in the restaurant information DB 12b, a restaurant ID, a table type ID, the number of seats, the acceptable number of persons, the number of vacant tables, and a registration date and time are registered in association with each other. The dish provider can register the vacant seat information for each type of table. The restaurant ID indicates a restaurant whose vacant seat information is registered. The number of seats is a fixed seating capacity of a table of a type indicated by the table type ID. The acceptable number of persons is the number of persons accepted by a table of a type indicated by the table type ID. The number of vacant tables is the number of vacant tables among tables of a type indicated by the table type ID. The registration date and time is a date and time at which the vacant seat information is registered. The number of seats and the acceptable number of persons need not be stored in the vacant seat information. This is because the number of seats and the acceptable number of persons can be acquired from the seat information registered in the restaurant information DB 12b on the basis of the restaurant ID and the table type ID stored in the vacant seat information. In other words, the table type ID stored in the vacant seat information is information indicating the number of vacant seats.

FIG. 4E is a diagram showing an example of content registered in the reservation information DB 12d. In the reservation information DB 12d, reservation information indicating reservation content of a restaurant is registered. The reservation information is also information indicating a history of the reservation. Specifically, in the reservation information DB 12d, a reservation number, a reservation date and time, a user ID, a restaurant ID, the reserved number of persons, a reserved table type ID, the number of reserved tables, the number of reserved seats, the number of points to be acquired, and the like are registered in association with each other every time a reservation is accepted. The reservation number is information identifying reservation information. The reservation date and time is a date and time when the reservation was made. The user ID indicates a user who made the reservation. The restaurant ID indicates the reserved restaurant. The reserved number of persons is the number of using-persons who reserve the restaurant. The reserved table type ID is a table ID of a type of the reserved table. The number of reserved tables is the number of tables that are reserved. The number of reserved seats is the number of seats of the reserved tables. The number of points to be acquired is the number of points that will be acquired by a user when the user uses the restaurant.

Next, other information stored in the storage unit 12 will be described. The storage unit 12 stores various data such as HTML documents, XML (Extensible Markup Language) documents, image data, text data, and electronic documents for displaying web pages. The storage unit 12 also stores various setting values, threshold values, constants, and the like.

Further, the storage unit 12 stores various programs such as an operating system, a WWW (World Wide Web) server program, a DBMS (Database Management System), and a restaurant search site management program. The restaurant search site management program is a program for performing various processes related to searching for restaurants, reserving a restaurant, and the like. The restaurant search site management program is an example of an information processing program of the present invention. For example, the various programs may be acquired from another server device or the like through the network NW or may be recorded in a recording medium such as a DVD (Digital Versatile Disc) and read through a drive device. The restaurant search site management program may be a program product.

The input/output interface 13 performs interface processing among the communication unit 11, the storage unit 12, and the system control unit 14.

FIG. 5 is a block diagram showing an example of functional blocks of the restaurant search server 1 according to the present embodiment. The system control unit 14 includes a CPU 14a, a ROM (Read Only Memory) 14b, a RAM (Random Access Memory) 14c, and the like. In the system control unit 14, the CPU 14a reads and executes various programs, so that the system control unit 14 functions as a search request acquisition unit 141, a strict search unit 142, a crampedness search unit 143, a point processing unit 144, a search result presentation unit 145, and a reservation processing unit 146, and the like as shown in FIG. 5. The search request acquisition unit 141 is an example of a person number acquisition means and a user-specified search method acquisition means of the present invention. A combination of the strict search unit 142 and the crampedness search unit 143 is an example of a search means of the present invention. The crampedness search unit 143 is an example of an acceptable person number acquisition means and an establishment-specified search method acquisition means of the present invention. The point processing unit 144 is an example of a privilege determination means of the present invention. The search result presentation unit 145 is an example of a presentation control means of the present invention.

The search request acquisition unit 141 acquires a search request transmitted from the user terminal 3 through the communication unit 11. The search request is a message indicating a request of searching for restaurants. The search request includes search conditions specified by a user. The search conditions include the number of using-persons. The search request acquisition unit 141 acquires the search conditions from the search request.

The strict search unit 142 performs the strict search based on the search conditions acquired by the search request acquisition unit 141. Specifically, the strict search unit 142 searches for restaurants where the number of vacant seats is larger than or equal to the number of using-persons and which satisfy search conditions other than the number of using-persons.

The crampedness search unit 143 performs the crampedness search based on the search conditions acquired by the search request acquisition unit 141. Specifically, the crampedness search unit 143 searches for restaurants where the number of vacant seats is smaller than the number of using-persons and the acceptable number of persons is larger than or equal to the number of using-persons and which satisfy search conditions other than the number of using-persons.

The point processing unit 144 calculates the number of points to be acquired when a user uses the restaurant found by the crampedness search unit 143. When the point processing unit 144 determines that the user indicates an intention to use a restaurant found by the crampedness search unit 143, the point processing unit 144 adds the number of points to be acquired to the number of points held by the user.

The search result presentation unit 145 causes the user terminal 3 to present restaurants found by at least one of the strict search unit 142 and the crampedness search unit 143 to the user. Specifically, the search result presentation unit 145 generates a search result page. The search result page is a web page on which the search result of restaurants is displayed. At this time, the search result presentation unit 145 generates the search result page so that the search result of the strict search unit 142 and the search result of the crampedness search unit 143 are displayed in a form in which they can be distinguished from each other. The search result presentation unit 145 transmits the generated search result page to the user terminal 3.

The reservation processing unit 146 performs processing related to reservation of a restaurant. For example, the reservation processing unit 146 registers reservation information in the reservation information DB 12d on the basis of a request from the user terminal 3. Further, the reservation processing unit 146 updates the vacant seat information registered in the vacant seat information DB 12c according to registration of the reservation information.

### 1-4. Operation of Information Processing System

Next, an operation of the information processing system S will be described with reference to FIGS. 6 to 11.

### 1-4-1. Entire Operation of Information Processing System

FIG. 6 is a sequence diagram showing a process overview of the information processing system S according to the present embodiment. For example, the dish provider of the restaurant operates the restaurant terminal 2 and selects whether or not to allow the search using the flexible search for the restaurant of the dish provider. If it is selected to allow the flexible search, the restaurant terminal 2 transmits a flexible search permission setting request (step S1). The restaurant search server 1 that receives the flexible search permission setting request sets the flexible search permission flag of the corresponding restaurant to TRUE (step S2). On the other hand, if the dish provider selects not to allow the flexible search, the restaurant terminal 2 transmits a flexible search non-permission setting request. In this case, the restaurant search server 1 sets the flexible search permission flag to FALSE.

For example, the dish provider inputs the acceptable number of persons into the restaurant terminal 2 for each type of table. The restaurant terminal 2 transmits the vacant seat information to the restaurant search server 1 for each pair of the table type ID and the acceptable number of persons (step S3). The restaurant search server 1 searches from the restaurant information DB 12b for the seat information corresponding to the restaurant ID and the table type ID stored in the received vacant seat information. Then, the restaurant search server 1 registers the acceptable number of persons stored in the vacant seat information in the found seat information (step S4).

The dish provider checks circumstances in the restaurant at any time and registers the vacant seat information in the restaurant terminal 2. For example, the dish provider inputs types of vacant tables and the number of vacant tables. Or, a list of types of tables may be displayed on a screen of the restaurant terminal 2. Thus, the dish provider may be able to select a type from the list and select the number of vacant tables. Or, a layout of tables in the restaurant may be displayed on the screen. The dish provider may select vacant tables from the layout, so that the restaurant terminal 2 may recognize the types of vacant tables and the number of vacant tables. The restaurant terminal 2 transmits the vacant seat information including the restaurant ID, the table type ID, and the number of vacant seats to the restaurant search server 1 (step S5). The restaurant search server 1 registers the received vacant seat information in the vacant seat information DB 12c (step S6). At this time, the restaurant search server 1 acquires the number of seats and the acceptable number of persons corresponding to the restaurant ID and the table type ID stored in the received vacant seat information from the seat information registered in the restaurant information DB 12b. Further, the restaurant search server 1 acquires the current date and time as the registration date and time. Then, the restaurant search server 1 adds the number of seats, the acceptable number of persons, and the registration date and time into the vacant seat information. The restaurant search server 1 may delete the registered vacant seat information if a predetermined time (for example, 30 minutes) has elapsed since the vacant seat information was registered. The reason of this is that old vacant seat information may not reflect the latest vacant seat status.

On the other hand, when the user operates the user terminal 3 and accesses the restaurant search server 1, the restaurant search server 1 transmits a top page of the restaurant search site to the user terminal 3. The user terminal 3 displays the top page on a screen.

FIG. 7A is a diagram showing a display example of the top page. The top page is a top web page in the restaurant search site. As shown in FIG. 7, the top page includes a condition setting area 100 and a region selection area 110. The condition setting area 100 is an area for inputting search conditions. In the condition setting area 100, a keyword input field 101, a category selection list box 102, a person number input field 103, a search method selection list box 104, a search button 105, and the like are displayed. The keyword input field 101 is an area for inputting a keyword. The category selection list box 102 is a list box for selecting a category of dishes provided in the restaurant. The person number input field 103 is an area for inputting the number of using-persons.

The search method selection list box 104 is a list box for selecting a search method. When a user selects the search method selection list box 104, as shown in FIG. 7B, a list of pieces of information indicating a search method is displayed. For example, “Restaurants having vacant seats corresponds to persons”, “Restaurants available regardless of the number of vacant seats”, and “Restaurants available even though vacant seats is less than persons” are displayed. The “Restaurants having vacant seats corresponds to persons” indicates that search is performed by the strict search. The “Restaurants available regardless of the number of vacant seats” indicates that search is performed by the flexible search. The “Restaurants available even though vacant seats is less than persons” indicates that search is performed by the crampedness search. For example, a user can select a search method on the basis of circumstances of the user such as the number of vacant seats has to be larger than or equal to the number of using-persons because the restaurant is used for a reception or it is ok for users to be able to just sit because the restaurant is used for a party of friends.

A user may be able to select the search method from only the strict search and the flexible search. A user need not be able to select the search method. For example, the restaurant search server 1 may perform the flexible search at all times. Or, for example, the restaurant search server 1 may first search for restaurants by the strict search. If the number of restaurants found at this time is smaller than a predetermined threshold value, for example, the restaurant search server 1 may next search for restaurants by the flexible search. Then, the restaurant search server 1 may present a search result of the strict search and a search result of the flexible search. An administrator of the restaurant search server 1 may freely set the threshold value. For example, the threshold value may be one or maybe two or more. Or, for example, the restaurant search server 1 may first search for restaurants by the strict search. If the number of restaurants found at this time is smaller than a predetermined threshold value, for example, the restaurant search server 1 may next search for restaurants by the crampedness search.

The search button 105 is a button to request the restaurant search server 1 to perform search. In the region selection area 110, a list of names of regions such as prefectures is displayed. A user can select a region as a search condition.

For example, the user inputs the number of using-persons in the person number input field 103 as a search condition and selects the flexible search from the search method selection list box 104 (step S7). The user specifies other search conditions as needed. Then, the user selects the search button 105, the user terminal 3 transmits a search request including the specified search conditions to the restaurant search server 1 (step S8).

The restaurant search server 1 that receives the search request searches for available restaurants based on the search conditions. The flexible search is specified as the search method, so that the restaurant search server 1 performs the flexible search. Specifically, the restaurant search server 1 performs the strict search on the basis of the number of vacant seats stored in the vacant seat information registered in the vacant seat information DB 12c and the number of using-persons which has been specified as a search condition. In other words, the restaurant search server 1 searches for restaurants where the number of vacant seats is larger than or equal to the number of using-persons (step S9). Further, the restaurant search server 1 performs the crampedness search on the basis of the acceptable number of persons stored in the vacant seat information registered in the vacant seat information DB 12c and the number of using-persons which has been specified as a search condition. In other words, the restaurant search server 1 searches for restaurants where the number of vacant seats is smaller than the number of using-persons and the degree by which the number of using-persons exceeds the number of vacant seats is smaller than or equal to the reference value (step S10). Further, the restaurant search server 1 calculates the number of points to be acquired for each found restaurant.

Next, the restaurant search server 1 generates a search result page on the basis of a search result of the flexible search. Then, the restaurant search server 1 transmits the search result page to the user terminal 3 (step S11). The user terminal 3 displays the received search result page on the screen (step S12).

FIG. 8A is a diagram showing a display example of the search result page. As shown in FIG. 8A, in the search result page, a strict search tab 200, a crampedness search tab 250, a strict search result area 210, and the like are displayed. The strict search tab 200 is a tab corresponding to the search result of the strict search. The crampedness search tab 250 is a tab corresponding to the search result of the crampedness search. In the initial state, the strict search tab 200 is selected and the crampedness search tab 250 is not selected. In the strict search result area 210, the search result of the strict search is displayed. Since the strict search tab 200 is selected, the strict search result area 210 is displayed. In the strict search result area 210, found restaurant information 220 is displayed for each restaurant found by the crampedness search. The found restaurant information 220 is information of a found restaurant. As the found restaurant information 220, for example, information such as an image of the restaurant, a restaurant name, a budget, how to get to the restaurant, and the like is displayed.

FIG. 8A shows an example in which the user specifies six as the number of using-persons. Therefore, the found restaurant information 220 of restaurants where the number of vacant seats is larger than or equal to six is displayed. The restaurant where the number of vacant seats is larger than or equal to six has a different meaning between the division-is-not-allowed-oriented thinking and the division-is-allowed-oriented thinking. In the division-is-not-allowed-oriented thinking, restaurants where at least one table having six or more seats is vacant are shown. In the division-is-allowed-oriented thinking, restaurants where there are six or more vacant seats when summing up the number of seats of all vacant tables (or when summing up the number of seats of vacant tables adjacent to each other) are shown.

When the user selects the crampedness search tab 250, as shown in FIG. 8B, the strict search result area 210 disappears and a crampedness search result area 260 is displayed. In the crampedness search result area 260, the search result of the crampedness search is displayed. In the crampedness search result area 260, found restaurant information 270 is displayed for each restaurant found by the crampedness search. The found restaurant information 270 is information of a found restaurant. As the found restaurant information 270, for example, an image of the restaurant, a restaurant name, a budget, how to get to the restaurant, a vacant seat status 271, point information 272, and the like are displayed. In the vacant seat status 271, a status of vacant seats is displayed. For example, as the vacant seat status 271, information such as “A table with four seats is vacant” is displayed. As the point information 272, for example, a message indicating that points are given to the user when the user reserves the restaurant and uses the restaurant and the number of points to be acquired are shown.

As shown in FIGS. 8A and 8B, the search result of the strict search and the search result of the crampedness search are displayed so that they can be distinguished from each other. When the user selects the strict search in the search method selection list box 104, in the search result page, the strict search tab 200 and the strict search result area 210 are displayed and the crampedness search tab 250 is not displayed. When the user selects the crampedness search in the search method selection list box 104, in the search result page, the crampedness search tab 250 and the crampedness search result area 260 are displayed and the strict search tab 200 is not displayed. When the user selects the strict search and thereby the restaurant search server 1 performs search by the strict search, if the number of found restaurants is smaller than a predetermined threshold value, the restaurant search server 1 may search for restaurants by the flexible search or the crampedness search. In this case, the strict search tab 200 and the crampedness search tab 250 are displayed in the search result page, and the strict search result area 210 or the crampedness search result area 260 is displayed according to a tab operation of the user.

A form in which the search result of the strict search and the search result of the crampedness search can be distinguished from each other is not limited to the form shown in FIGS. 8A and 8B. For example, the restaurant search server 1 may generate the search result page so that the strict search result area 210 and the crampedness search result area 260 are displayed at the same time. Further, for example, the restaurant search server 1 may generate the search result page so that the found restaurant information 220 and the found restaurant information 270 are mixed and displayed in one area. The user can identify information of restaurants found by the strict search and information of restaurants found by the crampedness search from the presence or absence of the vacant seat status 271. Further, for example, the restaurant search server 1 may generate the search result page so that, for example, at least one of a background color of the area, the size of the area, a color of characters, the size of the characters, and a style of the characters is different between the found restaurant information 220 and the found restaurant information 270. At this time, the restaurant search server 1 may generate the search result page so that a display form of the found restaurant information 220 is seen more easily than a display form of the found restaurant information 270.

In the search result page, if the user selects any one piece of the found restaurant information 220 and the found restaurant information 270, a restaurant page of a corresponding restaurant is displayed on the screen of the user terminal 3. For example, the user selects the found restaurant information 270 of a desired restaurant from the crampedness search result area 260 (step S13). Then, a restaurant page of a restaurant D is displayed. If the user performs an operation for reservation in the restaurant page, the user terminal 3 displays a web page for performing a reservation procedure. When the user inputs necessary information (step S14), the user terminal 3 transmits a reservation request to the restaurant search server 1 (step S15).

The restaurant search server 1 that receives the reservation request registers reservation information (step S16). Specifically, the restaurant search server 1 acquires the table type ID and the number of seats from the vacant seat information where the number of vacant tables is larger than or equal to one among pieces of the vacant seat information of the restaurant to be reserved in the vacant seat information DB 12c. Further, the restaurant search server 1 generates a new reservation number. The restaurant search server 1 generates the reservation information including a reservation number, a user ID of the user who made the reservation, a restaurant ID of the restaurant to be reserved, the number of using-persons (the reserved number of persons) specified as a search condition, the table type ID (the reserved table type ID) acquired from the vacant seat information, the number of seats (the number of reserved seats) acquired from the seat information, the number of points to be acquired calculated for the restaurant to be reserved, and the like. Further, the restaurant search server 1 updates the vacant seat information of the restaurant to be reserved. Specifically, the restaurant search server 1 reduces the number of vacant tables corresponding to the reserved table type ID.

The reserved table type ID and the number of reserved seats stored in the reservation information may be different between the division-is-not-allowed-oriented thinking and the division-is-allowed-oriented thinking. In the division-is-not-allowed-oriented thinking, a restaurant where the number of vacant seats is smaller than the number of using-persons and the degree by which the number of using-persons exceeds the number of vacant seats is smaller than or equal to the reference value is, for example, a restaurant where the acceptable number of persons of a vacant table having the largest acceptable number of persons among vacant tables is larger than or equal to the number of using-persons. Therefore, when a plurality of pieces of vacant seat information of the restaurant to be reserved are registered, the restaurant search server 1 selects the vacant seat information where the acceptable number of persons is the largest among the plurality of pieces of vacant seat information. Then, the restaurant search server 1 determines the table type ID and the number of seats stored in the selected vacant seat information to be the reserved table type ID and the number of reserved seats. Further, the restaurant search server 1 sets 1 as the number of reserved tables.

In the division-is-allowed-oriented thinking, a restaurant where the number of vacant seats is smaller than the number of using-persons and the degree by which the number of using-persons exceeds the number of vacant seats is smaller than or equal to the reference value is, for example, a restaurant where the sum of the acceptable numbers of people of all vacant tables is larger than or equal to the number of using-persons. Therefore, the restaurant search server 1 calculates the sum of the numbers of vacant seats for one type of table by multiplying together the number of seats and the number of vacant tables which are stored in the vacant seat information of the restaurant to be reserved. When only one piece of vacant seat information of the restaurant to be reserved is acquired, the calculated sum is the number of vacant seats in the entire restaurant. On the other hand, when a plurality of pieces of vacant seat information of the restaurant to be reserved are registered, the restaurant search server 1 calculates the number of vacant seats in the entire restaurant by summing up the sums of the numbers of vacant seats of each piece of vacant seat information. The restaurant search server 1 determines the number of vacant seats in the entire restaurant to be the number of reserved seats. When a plurality of pieces of vacant seat information of the restaurant to be reserved are registered, the restaurant search server 1 determines the table type ID and the number of vacant tables stored in each piece of vacant seat information to be the reserved table type ID and the number of reserved tables, respectively. As a result, a plurality of combinations of the reserved table type ID and the number of reserved tables are stored in the reservation information.

When the reservation is completed, the restaurant search server 1 transmits a reservation completion page to the user terminal 3 (step S17). The user terminal 3 displays the received reservation completion page on the screen. FIG. 9 is a diagram showing a display example of the reservation completion page. As shown in FIG. 9, in the reservation completion page, for example, a message indicating that the reservation is completed and a coupon information 300 are displayed. The coupon information 300 is information required for the user to acquire points by using the reserved restaurant. As the coupon information 300, for example, the reservation number, the reservation date and time, a name of the reserved restaurant, a name of the user who made the reservation, a condition to acquire points, the number of points to be acquired, and a one-dimensional or two-dimensional code indicating the visit information are displayed. The visit information includes, for example, the reservation number. As the condition to acquire points, the reserved number of persons and the number of reserved seats are displayed.

The restaurant search server 1 notifies the restaurant to be reserved of the content of the reservation (step S18). The content of the notification includes, for example, the reservation number, the reservation date and time, the name of the user who made the reservation, and the condition to acquire points. The restaurant search server 1 may notify the restaurant to be reserved of the content of the reservation by, for example, transmitting an e-mail to the restaurant.

Thereafter, a group of users comes to the reserved restaurant and shows the coupon information 300 to the dish provider. The dish provider checks the coupon information 300. If the dish provider determines that the number of members of the group of users corresponds to the reserved number of persons and confirms that a table having seats of which the number is equal to the number of reserved seats is vacant, the dish provider inputs the visit information from the code of the coupon information 300. The restaurant terminal 2 transmits the inputted visit information to the restaurant search server 1 (step S20).

The restaurant search server 1 performs a process to provide points to a user who comes to the restaurant on the basis of the received visit information (step S21). Specifically, the restaurant search server 1 acquires the reservation number from the visit information. The restaurant search server 1 acquires the reservation information corresponding to the reservation number from the reservation information DB 12d. The restaurant search server 1 acquires the user ID and the number of points to be acquired from the reservation information. Then, the restaurant search server 1 adds the number of points to be acquired to the number of held points corresponding to the user ID in the member information DB 12a.

### 1-4-2. Operation of Restaurant Search Server

FIG. 10 is a flowchart showing an example of a search process of the system control unit 14 of the restaurant search server 1 according to the present embodiment. The search process is started when the restaurant search server 1 receives the search request from the user terminal 3.

As shown in FIG. 10, the search request acquisition unit 141 acquires the search conditions from the search request (step S31). Next, the search request acquisition unit 141 determines whether or not the search method specified as a search condition is the crampedness search (step S32). At this time, if the search request acquisition unit 141 determines that the search method is not the crampedness search (step S32: NO), the search request acquisition unit 141 proceeds to step S33. In this case, the search method is the strict search or the flexible search. On the other hand, if the search request acquisition unit 141 determines that the search method is the crampedness search (step S32: YES), the search request acquisition unit 141 proceeds to step S35.

In step S33, the strict search unit 142 performs the strict search. Specifically, the strict search unit 142 searches for restaurants where the search conditions other than the search method and the number of using-persons are satisfied on the basis of the restaurant information registered in the restaurant information DB 12b. Next, the strict search unit 142 searches for restaurants where the number of vacant seats is larger than or equal to the number of using-persons from among the found restaurants. The search method is different between the division-is-not-allowed-oriented thinking and the division-is-allowed-oriented thinking. In the case of the division-is-not-allowed-oriented thinking, the strict search unit 142 acquires the vacant seat information where the number of vacant tables is larger than or equal to one among pieces of the vacant seat information of the restaurants where the search conditions other than the search method and the number of using-persons are satisfied from the vacant seat information DB 12c. The strict search unit 142 determines whether or not the number of seats stored in the acquired vacant seat information is larger than or equal to the number of using-persons. If a plurality of pieces of vacant seat information of the same restaurant are acquired, the strict search unit 142 performs the determination based on, for example, the largest number of seats among the numbers of seats stored in the plurality of pieces of vacant seat information. The strict search unit 142 registers the restaurant ID of the restaurant where the number of seats is determined to be larger than or equal to the number of using-persons to a search result list of the strict search. In the case of the division-is-allowed-oriented thinking, the strict search unit 142 acquires the vacant seat information of the restaurants where the search conditions other than the search method and the number of using-persons are satisfied from the vacant seat information DB 12c. The strict search unit 142 calculates the sum of the numbers of vacant seats for one type of table by multiplying together the number of seats and the number of vacant tables which are stored in the vacant seat information. When only one piece of vacant seat information of the same restaurant is acquired, the calculated sum is the number of vacant seats in the entire restaurant. On the other hand, when a plurality of pieces of vacant seat information of the same restaurant are acquired, the strict search unit 142 calculates the number of vacant seats in the entire restaurant by summing up the sums of the numbers of vacant seats of each piece of vacant seat information. The strict search unit 142 determines whether or not the number of vacant seats in the entire restaurant is larger than or equal to the number of using-persons. Then, the strict search unit 142 registers the restaurant ID of the restaurant where the number of vacant seats in the entire restaurant is determined to be larger than or equal to the number of using-persons to the search result list of the strict search.

After step S33, the search request acquisition unit 141 determines whether or not the search method specified as a search condition is the strict search (step S34). At this time, if the search request acquisition unit 141 determines that the search method is the strict search (step S34: YES), the search request acquisition unit 141 proceeds to step S46. On the other hand, if the search request acquisition unit 141 determines that the search method is not the strict search (step S34: YES), the search request acquisition unit 141 proceeds to step S35. In this case, the search method is the flexible search.

In step S46, the strict search unit 142 determines whether or not the number of found restaurants is smaller than a threshold value. At this time, if the strict search unit 142 determines that the number of found restaurants is smaller than the threshold value (step S46: YES), the strict search unit 142 proceeds to step S35. On the other hand, if the strict search unit 142 determines that the number of found restaurants is larger than or equal to the threshold value (step S46: NO), the strict search unit 142 proceeds to step S45.

In steps S35 to S44, the crampedness search unit 143 performs the crampedness search. In step S35, the crampedness search unit 143 searches for restaurants where the search conditions other than the search method and the number of using-persons are satisfied on the basis of the restaurant information registered in the restaurant information DB 12b. Next, the crampedness search unit 143 searches for restaurants which allow the flexible search from among the restaurants where the search conditions other than the search method and the number of using-persons are satisfied. Specifically, the crampedness search unit 143 searches for restaurant IDs where the flexible search permission flag is set to TRUE from the restaurant information DB 12b. Next, the crampedness search unit 143 selects one of the restaurants which allow the flexible search (step S36). Next, the crampedness search unit 143 determines whether or not the vacant seat information which is the vacant seat information of the selected restaurant and where the number of vacant tables is set to one or more is registered in the vacant seat information DB 12c (step S37). At this time, if the crampedness search unit 143 determines that the vacant seat information is registered (step S37: YES), the crampedness search unit 143 proceeds to step S38. On the other hand, if the crampedness search unit 143 determines that the vacant seat information is not registered (step S37: NO), the crampedness search unit 143 proceeds to step S43.

In step S38, the crampedness search unit 143 acquires the vacant seat information where the number of vacant tables is set to larger than or equal to one among pieces of the vacant seat information of the selected restaurants from the vacant seat information DB 12c. Next, the crampedness search unit 143 determines whether or not the number of vacant seats is larger than or equal to the number of using-persons on the basis of the acquired vacant seat information (step S39). The determination method is the same as that in step S33. At this time, if the crampedness search unit 143 determines that the number of vacant seats is larger than or equal to the number of using-persons (step S39: YES), the crampedness search unit 143 proceeds to step S43. On the other hand, if the crampedness search unit 143 determines that the number of vacant seats is smaller than the number of using-persons (step S39: NO), the crampedness search unit 143 proceeds to step S40.

In step S40, the crampedness search unit 143 determines whether or not the acceptable number of persons is larger than or equal to the number of using-persons on the basis of the acquired vacant seat information. The determination method is different between the division-is-not-allowed-oriented thinking and the division-is-allowed-oriented thinking. In the case of the division-is-not-allowed-oriented thinking, the crampedness search unit 143 determines whether or not the acceptable number of persons stored in the acquired vacant seat information is larger than or equal to the number of using-persons. If a plurality of pieces of vacant seat information of the same restaurant are acquired, the crampedness search unit 143 performs the determination based on, for example, the largest acceptable number of persons among the acceptable numbers of people stored in the plurality of pieces of vacant seat information. In the case of the division-is-allowed-oriented thinking, the crampedness search unit 143 calculates the sum of the acceptable numbers of people for one type of table by multiplying together the acceptable number of persons and the number of vacant tables which are stored in the vacant seat information. When only one piece of vacant seat information of the same restaurant is acquired, the calculated sum is the acceptable number of persons in the entire restaurant. On the other hand, when a plurality of pieces of vacant seat information of the same restaurant are acquired, the crampedness search unit 143 calculates the acceptable number of persons in the entire restaurant by summing up the sums of the acceptable numbers of people of each piece of vacant seat information. The crampedness search unit 143 determines whether or not the acceptable number of persons in the entire restaurant is larger than or equal to the number of using-persons. If the crampedness search unit 143 determines that the acceptable number of persons is larger than or equal to the number of using-persons (step S40: YES), the crampedness search unit 143 proceeds to step S41. On the other hand, if the crampedness search unit 143 determines that the acceptable number of persons is smaller than the number of using-persons (step S40: NO), the crampedness search unit 143 proceeds to step S43.

In step S41, the point processing unit 144 performs a point calculation process. FIG. 11 is a flowchart showing an example of the point calculation process of the system control unit 14 of the restaurant search server 1 according to the present invention. As shown in FIG. 11, the point processing unit 144 calculates the number of points according to the number of using-persons which has been specified as a search condition. For example, the point processing unit 144 calculates the number of points so that the larger the number of using-persons, the larger the number of points. Then, the point processing unit 144 sets the number of points to be acquired to the calculated number of points (step S61).

Next, the point processing unit 144 calculates a distance from the user terminal 3 to the selected restaurant (step S62). For example, when the user terminal 3 has the current position measuring function, the user terminal 3 transmits a search request including, for example, position information of the current position of the user terminal 3. The position information is, for example, information indicating the longitude and latitude. The point processing unit 144 identifies the position information of the position of the restaurant on the basis of the address of the selected restaurant. Then, the point processing unit 144 calculates the distance based on the position information of the user terminal 3 and the position information of the restaurant. When the user terminal 3 does not have the current position measuring function, the point processing unit 144 may use the address of the user.

After step S62, the point processing unit 144 calculates the number of points according to the calculated distance. For example, the point processing unit 144 calculates the number of points so that the longer the distance, the larger the number of points. Then, the point processing unit 144 adds the calculated number of points to the number of points to be acquired (step S63). Then, the point processing unit 144 ends the point calculation process.

When the point calculation process ends, as shown in FIG. 10, the crampedness search unit 143 registers the restaurant ID of the selected restaurant, the table type ID stored in the vacant seat information, and the calculated number of points to be acquired in a search result list for the crampedness search (step S42). The table type ID to be registered is the table type ID corresponding to the acceptable number of persons used for the determination in step S39. Subsequently, the crampedness search unit 143 proceeds to step S43.

In step S43, the crampedness search unit 143 determines whether or not there are one or more restaurants that have not yet been selected among the restaurants which allow the flexible search. At this time, if the crampedness search unit 143 determines that there are one or more restaurants that have not yet been selected (step S43: YES), the crampedness search unit 143 proceeds to step S44. In step S44, the crampedness search unit 143 selects one of the restaurants that have not yet been selected. Subsequently, the crampedness search unit 143 proceeds to step S37. On the other hand, if the crampedness search unit 143 determines that all the restaurants have been selected (step S43: NO), the crampedness search unit 143 proceeds to step S45.

In step S45, the search result presentation unit 145 generates an HTML document of the search result page based on the search result list. Specifically, when the strict search is performed, the search result presentation unit 145 acquires the restaurant information corresponding to the restaurant ID registered in the search result list of the strict search from the restaurant DB 12b. The search result presentation unit 145 generates data to display the found restaurant information 220 based on the restaurant information. Then, the search result presentation unit 145 adds the generated data to the HTML document of the search result page. When the crampedness search is performed, the search result presentation unit 145 acquires the restaurant information corresponding to the restaurant ID registered in the search result list of the crampedness search from the restaurant DB 12b. The search result presentation unit 145 generates data to display the found restaurant information 270 based on the restaurant information as well as the table type ID and the number of points to be acquired which are registered in the search result list of the crampedness search. Then, the search result presentation unit 145 adds the generated data to the HTML document of the search result page. The search result presentation unit 145 transmits the generated HTML document to the user terminal 3 that is the transmission source of the search request. Then, the search result presentation unit 145 ends the search process.

The user terminal 3 displays, for example, a search result page as shown in FIG. 8 on the screen on the basis of the received HTML document. The search result presentation unit 145 causes the user terminal 3 to present the found restaurants to the user by transmitting the HTML document of the search result page to the user terminal 3.

As described above, according to the present embodiment, the system control unit 14 acquires the number, specified by the user, of persons who use the restaurant, searches for restaurants that can be used by persons of which the number is acquired on the basis of the vacant seat information stored in the storage unit 12 that stores the vacant seat information indicating the number of vacant seats, in units of using-persons, of chairs occupied by users of a restaurant, includes restaurants where the degree by which the number of using-persons exceeds the number of vacant seats indicated by the vacant seat information is smaller than or equal to the reference value in available restaurants, and causes the found restaurants to be presented. Therefore, it is possible to present a restaurant which are not conventionally presented due to the relationship between the number of persons which is specified by the user and the number of vacant seats even though the restaurant really can be used by persons of which the number is specified by the user.

Further, the system control unit 14 determines the privilege to be given to the user on condition that the intention that persons of which the number is the umber of using-persons which has been acquired use a restaurant where the number of seats of a vacant table is smaller than the number of using-persons among the found restaurants is confirmed. Therefore, it is possible to prompt the user to decide that persons who is more than vacant seats use a restaurant.

Further, the larger the number of using-persons, the higher the system control unit 14 raises the value of the privilege to be given. Therefore, it is possible to further prompt the user to decide that persons who is more than vacant seats use a restaurant.

Further, the system control unit 14 acquires the acceptable number of persons corresponding to the number of vacant seats indicated by the vacant seat information of a restaurant stored in the storage unit 12 from the storage unit 12 that stores the acceptable number of persons which is specified by a restaurant and which is larger than the number of vacant seats, and searches for restaurants where the acquired acceptable number of persons is larger than or equal to the number of using-persons. Accordingly, the restaurant can specify how much larger the acceptable number of persons is than the number of vacant seats. Therefore, it is possible to perform a search suitable for restaurants.

Further, the system control unit 14 acquires any one method of the strict search, the crampedness search, and the flexible search, which are search methods specified by a restaurant as a method in which the restaurant is searched for, as, for example, the flexible search permission setting request or the flexible search non-permission setting request, or the flexible search permission flag, searches for restaurants by using any one of the search methods, which are the strict search, the crampedness search, and the flexible search, and searches for restaurants from among restaurants where the search method specified by the restaurant corresponds to the search method used for the search. Accordingly, in a relationship between the number of vacant seats and the number of persons, a restaurant can specify the search method by which a search for the restaurant is allowed. Therefore, it is possible to perform a search considering the circumstances of the restaurants.

Further, the system control unit 14 acquires any one method of the strict search, the crampedness search, and the flexible search, which are search methods specified by a user, and searches for restaurants by using the acquired search method. Accordingly, in a relationship between the number of vacant seats and the number of persons, the user can specify a method of searching for restaurants. Therefore, it is possible to perform a search considering the circumstances of the user.

In the present embodiment, the table type ID is used. However, the table type ID is not essential information. In the case of the division-is-not-allowed-oriented thinking, for example, the restaurant search server 1 may be configured so that the acceptable number of persons and the number of vacant seats can be registered in association with the number of seats of a table. In the case of the division-is-allowed-oriented thinking, for example, the restaurant search server 1 may be configured so that the acceptable number of persons can be registered in association with the number of seats in the entire restaurant. Or, the restaurant search server 1 may be configured so that the number of vacant seats in the entire restaurant can be registered as the vacant seat information.

### 2. Second Embodiment

In the first embodiment, the dish provider of the restaurant can set the acceptable number of persons for the number of seats. The restaurant search server 1 searches for restaurants where the acceptable number of persons is larger than or equal to the number of using-persons. On the other hand, in the second embodiment described below, the user can specify an acceptable number of seats when specifying the search conditions. The acceptable number of seats is a minimum number of seats accepted by the user for the number of using-persons. The acceptable number of seats is smaller than the number of using-persons. The restaurant search server 1 searches for restaurants where the number of vacant seats is larger than or equal to the acceptable number of seats.

FIG. 12 is a diagram showing a display example of a top page. In FIG. 12, the same components as those in FIG. 7 are denoted by the same reference numerals. As shown in FIG. 12, the top page includes a condition setting area 100 and a region selection area 110. In the condition setting area 100, a keyword input field 101, a category selection list box 102, a person number input field 103, a seat number input field 106, a search button 105, and the like are displayed.

The seat number input field 106 is an area for inputting the acceptable number of seats. For example, the user can input the acceptable number of seats, which is smaller than the number of using-persons inputted into the person number input field 103, into the seat number input field 106. An unrealistic acceptable number of seats for the number of using-persons may not be able to be inputted. For example, if the acceptable number of seats is two even though the number of using-persons is 10, there is a probability that the acceptable number of seats is too small. For example, an administrator of the restaurant search server 1 may set a ratio of a minimum value of the acceptable number of seats that can be inputted corresponding to the number of using-persons in advance.

If the user does not input the acceptable number of seats, the restaurant search server 1 assumes that the user selects the strict search as the search method. If the user inputs the acceptable number of seats, the restaurant search server 1 assumes that the user selects the flexible search as the search method. A category selection list box 102 may be displayed in the condition setting area 100. Input into the seat number input field 106 may be allowed only when the user selects the flexible search or the crampedness search from the category selection list box 102. When the user selects the search button 105, the user terminal 3 transmits a search request in which search conditions including the number of using-persons and the acceptable number of seats are set to the restaurant search server 1. The search request acquisition unit 141 acquires the search conditions including the number of using-persons and the acceptable number of seats from the search request. The search request acquisition unit 141 is an example of an acceptable seating capacity acquisition means of the present invention.

In the present embodiment, the acceptable number of persons need not be included in the seat information registered in the restaurant information DB 12b. Further, the acceptable number of persons need not be included in the seat information registered in the vacant seat information DB 12c.

FIG. 13 is a flowchart showing an example of a search process of the system control unit 14 of the restaurant search server 1 according to the present embodiment. In FIG. 13, the same components as those in FIG. 10 are denoted by the same reference numerals.

As shown in FIG. 13, after steps S31 and S33 are performed, the search request acquisition unit 141 determines whether or not the acceptable number of seats is specified as a search condition (step S81). At this time, if the search request acquisition unit 141 determines that the acceptable number of seats is not specified (step S81: NO), the search request acquisition unit 141 proceeds to step S45. On the other hand, if the search request acquisition unit 141 determines that the acceptable number of seats is specified (step S81: YES), the search request acquisition unit 141 proceeds to step S35. In the same manner as in the first embodiment, steps S35 to S39 are performed. In step S39, if the crampedness search unit 143 determines that the number of vacant seats is smaller than the number of using-persons (step S39: NO), the crampedness search unit 143 proceeds to step S82.

In step S82, the crampedness search unit 143 determines whether or not the number of vacant seats is larger than or equal to the acceptable number of seats on the basis of the acquired vacant seat information. The determination method in step S82 is the same as that in step S40 in FIG. 10 except that the number of seats stored in the vacant seat information is used instead of the acceptable number of persons and the acceptable number of seats is used instead of the number of using-persons. If the crampedness search unit 143 determines that the number of vacant seats is larger than or equal to the acceptable number of seats (step S82: YES), the crampedness search unit 143 proceeds to step S41. On the other hand, if the crampedness search unit 143 determines that the number of vacant seats is smaller than the user acceptable number of seats (step S82: NO), the crampedness search unit 143 proceeds to step S43. In the same manner as in the first embodiment, steps S41 to S45 are performed.

The second embodiment is the same as the first embodiment except for the points described above. As described above, according to the present embodiment, the system control unit 14 acquires an acceptable seating capacity which is specified by the user as a fixed seating capacity for the number of using-persons and which is smaller than the number of using-persons and searches for restaurants where the fixed seating capacity indicated by the vacant seat information is larger than or equal to the acquired acceptable seating capacity. Therefore, the user can specify how much smaller the acceptable seating capacity is than the number of members of the group of the user. Therefore, it is possible to perform a search suitable for the user.

### 3. Third Embodiment

In the first embodiment, the dish provider specifies the acceptable number of persons, and in the second embodiment, the user specifies the acceptable seating capacity. In the third embodiment described below, the restaurant search server 1 estimates the reference value by using the reservation information registered in the reservation information DB 12d as histories of reservation.

For example, the restaurant search server 1 estimates the acceptable number of persons for each number of seats. The acceptable number of persons is estimated for the number of seats, so that a relationship between the number of seats and the number of persons in which a table is allowed to be used is estimated. The restaurant search server 1 uses reservation histories where the numbers of reserved seats is smaller than the reserved numbers of persons. For example, the restaurant search server 1 my infer that a maximum value among the numbers of persons that has been reserved so far for a certain number of seats is the acceptable number of persons for the number of seats. Or, the restaurant search server 1 may infer that, For example, N-th percentile among the numbers of persons that has been reserved so far is the acceptable number of persons. The administrator of the restaurant search server 1 may freely set N. Instead of the acceptable number of persons, the restaurant search server 1 may infer, for example, a ratio of the acceptable number of persons to the number of seats as a scale factor or a difference between the acceptable number of persons and the number of seats.

The restaurant search server 1 estimates the acceptable number of persons which is common in all restaurants on the basis of the reservation information of all the restaurants. The reason of this is that the reservation information of one restaurant may be too small to estimate the acceptable number of persons. The restaurant search server 1 may estimate the acceptable number of persons for each restaurant.

In order to estimate the acceptable number of persons, it is required that the restaurant be reserved by the number of persons larger than the number of seats. So, the restaurant search server 1 needs to search for restaurants where the number of vacant seats is smaller than the number of using-persons and display information of the found restaurants on the search result page. For example, when the user selects the strict search as the search method and thereby the restaurant search server 1 performs the strict search, if the number of found restaurants is smaller than a predetermined threshold value, the restaurant search server 1 may search for restaurants that satisfy the search conditions other than the number of vacant seats from among restaurants where there is a vacant table. An administrator of the restaurant search server 1 may freely set the threshold value. For example, the threshold value may be one or maybe two or more. The restaurant search server 1 may generate the search result page so that a vacant seat status such as “A table with four seats is vacant” is displayed as one of information of the restaurants found in this way. When the user reserves a found restaurant, the restaurant is reserved by the number of persons larger than the number of seats. In the present embodiment, the search conditions may be specified on a web page that is the same as the top page shown in FIG. 7A.

FIG. 14A is a block diagram showing an example of a schematic configuration of the restaurant search server 1 according to the present embodiment. A difference of FIG. 14A from FIG. 3 is that an acceptable person number DB 12e is added to the storage unit 12. FIG. 14B is a diagram showing an example of content registered in the acceptable person number DB 12e. In the acceptable person number DB 12e, an estimated acceptable number of persons is registered. The estimated acceptable number of persons is the acceptable number of persons which is estimated. Specifically, in the acceptable person number DB 12e, the number of seats and the estimated acceptable number of persons are registered in association with each other for each number of seats. In the present embodiment, the acceptable number of persons need not be included in the seat information registered in the restaurant information DB 12b. Further, the acceptable number of persons need not be included in the seat information registered in the vacant seat information DB 12c.

FIG. 15 is a block diagram showing an example of functional blocks of the restaurant search server 1 according to the present embodiment. A difference of FIG. 15 from FIG. 5 is that an acceptable persons number estimation unit 147 is added. The acceptable persons number estimation unit 147 is an example of an estimation means of the present invention. The acceptable persons number estimation unit 147 estimates the estimated acceptable number of persons on the basis of the reservation information registered in the reservation information DB 12d.

FIG. 16 is a flowchart showing an example of an acceptable person number estimation process of the restaurant search server 1 according to the present embodiment. For example, the acceptable person number estimation process is periodically performed.

As shown in FIG. 16, the acceptable persons number estimation unit 147 initializes the acceptable person number DB 12e (S101). Next, the acceptable persons number estimation unit 147 searches for the reservation information where the number of reserved seats is smaller than the reserved number of persons from the reservation information DB 12d (step S102). Next, the acceptable persons number estimation unit 147 divides the found reservation information into groups for each number of reserved seats (step S103). Next, the acceptable persons number estimation unit 147 selects one of the groups of reservation information (step S104).

Next, on the basis of the reserved number of persons stored in the reservation information included in the selected group, the acceptable persons number estimation unit 147 estimates the acceptable number of persons for the number of reserved seats corresponding to the selected group (step S105). Then, the acceptable persons number estimation unit 147 determines the number of reserved seats corresponding to the selected group to be the number of seats and determines the acceptable number of persons which has been estimated to be the estimated acceptable number of persons. Next, the acceptable persons number estimation unit 147 registers the number of seats and the estimated acceptable number of persons in association with each other in the acceptable person number DB 12e (step S106).

Next, the acceptable persons number estimation unit 147 determines whether or not there are one or more groups that have not yet been selected (step S107). At this time, if the acceptable persons number estimation unit 147 determines that there are one or more groups that have not yet been selected (step S107: YES), the acceptable persons number estimation unit 147 proceeds to step S108. In step S108, the acceptable persons number estimation unit 147 selects one of the groups that have not yet been selected. Subsequently, the acceptable persons number estimation unit 147 proceeds to step S105. On the other hand, if the acceptable persons number estimation unit 147 determines that all the groups have been selected (step S107: NO), the acceptable persons number estimation unit 147 ends the acceptable person number estimation process.

FIG. 17 is a flowchart showing an example of a search process of the system control unit 14 of the restaurant search server 1 according to the present embodiment. In FIG. 17, the same components as those in FIG. 10 are denoted by the same reference numerals.

As shown in FIG. 17, in the same manner as in the first embodiment, steps S31 to S39 are performed. In step S34, if the search request acquisition unit 141 determines that the search method is the strict search (step S34: YES), the search request acquisition unit 141 proceeds to step S121. In step S121, the strict search unit 142 determines whether or not the number of found restaurants is smaller than a threshold value. At this time, if the strict search unit 142 determines that the number of found restaurants is smaller than the threshold value (step S121: YES), the strict search unit 142 proceeds to step S122. On the other hand, if the strict search unit 142 determines that the number of found restaurants is larger than or equal to the threshold value (step S121: NO), the strict search unit 142 proceeds to step S45.

In step S122, the strict search unit 142 searches, from among restaurants which satisfies the search conditions other than the search method and the number of using-persons, for restaurants where the vacant seat information in which the number of vacant tables is set to one or more is registered in the vacant seat information DB 12c. Then, the strict search unit 142 registers the restaurant IDs of the found restaurants in a search result list of an alternate search. Subsequently, the strict search unit 142 proceeds to step S45. In this case, the search result presentation unit 145 generates an HTML document of the search result page based on the search result list of the alternate search.

In step S39, if the crampedness search unit 143 determines that the number of vacant seats is smaller than the number of using-persons (step S39: NO), the crampedness search unit 143 proceeds to step S123. In step S123, the crampedness search unit 143 acquires the estimated acceptable number of persons corresponding to the number of vacant seats of the selected restaurant from the acceptable person number DB 12e. At this time, there is a case in which the estimated acceptable number of persons corresponding to the number of vacant seats is not registered in the acceptable person number DB 12e. This is a case in which there is no reservation which is made by the reserved number of persons larger than the number of reserved seats among reservations where the number of reserved seats is equal to the number of vacant seats of the selected restaurant. In this case, the crampedness search unit 143 may calculate the estimated acceptable number of persons corresponding to the number of vacant seats of the selected restaurant on the basis of the number of seats and the estimated acceptable number of persons registered in the acceptable person number DB 12e. For example, it is assumed that a reservation where the number of reserved seats is four has been made, while a reservation where the number of reserved seats is six has not been made. Further, it is assumed that the estimated acceptable number of persons is six when the number of seats is four. In this case, the crampedness search unit 143 may determine that the estimated acceptable number of persons is nine when the number of seats is six on the basis of the ratio between the number of seats and the estimated acceptable number of persons.

Next, the crampedness search unit 143 determines whether or not the acquired estimated acceptable number of persons is larger than or equal to the number of using-persons (step S124). If the crampedness search unit 143 determines that the estimated acceptable number of persons is larger than or equal to the number of using-persons (step S124: YES), the crampedness search unit 143 proceeds to step S41. On the other hand, if the crampedness search unit 143 determines that the estimated acceptable number of persons is smaller than the number of using-persons (step S124: NO), the crampedness search unit 143 proceeds to step S43. In the same manner as in the first embodiment, steps S41 to S45 are performed.

When the restaurant search server 1 estimates the relationship between the number of seats and the number of persons in which a table is allowed to be used, the restaurant search server 1 may estimate the acceptable seating capacity for each reserved number of persons who use the restaurant instead of estimating the acceptable number of persons. The acceptable seating capacity is estimated for the number of persons, so that the relationship between the number of seats and the number of persons in which a table is allowed to be used is estimated. The restaurant search server 1 may search for restaurants where the number of vacant seats is larger than or equal to the acceptable seating capacity corresponding to the number of using-persons which has been specified as a search condition.

The third embodiment is the same as the first embodiment except for the points described above. As described above, according to the present embodiment, the system control unit 14 estimates the reference value on the basis of the reservation histories of restaurants, which include the reserved number of persons who used the restaurant and the number of reserved seats smaller than the reserved number of persons, and includes restaurants where the degree by which the number of using-persons exceeds the number of vacant seats is smaller than or equal to the estimated reference value in the available restaurants. Therefore, it is possible for the restaurant and the user to save time and effort to specify a degree of allowance.

### 4. Fourth Embodiment

In the first to the third embodiments, the value of the privilege (the acquired number of points) which is calculated when a restaurant is searched for does not change thereafter. In the fourth embodiment described below, when the user moves farther away from the found restaurant after the restaurant is found, the restaurant search server 1 raises the value of the privilege.

Even if information of the restaurants found based on the search conditions specified by the user is displayed on the search result page, there may be no restaurant which the user wants to use among the found restaurants. Or, although there is a restaurant which the user is interested in among the found restaurants, the user may think that the user need not use the restaurant because the number of points which the user can acquire is small. Then, the user moves in a direction other than a direction toward a position at which the found restaurant is located. However, the user searched for restaurants in the restaurant search site, so that there is a probability that the user wants to go to a restaurant. At this time, if the number of points which the user can acquire increases, the user may change his or her mind and intend to use the restaurant. Therefore, if the user moves farther away from the restaurant after the search of the restaurant, the restaurant search server 1 determines that the user does not intend to use the found restaurant or determines that the user hesitates to use the found restaurant. At this time, the restaurant search server 1 increases the number of points to be acquired. Thereby, it is possible to expect an effect of preventing the user from leaving. In other words, it is possible to provide the user a chance to change his or her mind and intend to use the restaurant. When the user changes his or her mind and intends to use the restaurant, the restaurant can increase chances to provide dishes.

The user terminal 3 is a mobile device having the current position measuring function to identify the position of the user. In the present embodiment, when a distance from the position of the user to the position of the restaurant becomes smaller than or equal to a predetermined value, the restaurant search server 1 determines that the user actually goes to the restaurant. In other words, the restaurant search server 1 determines that the user shows intention to use the restaurant. For example, the restaurant search server 1 may check the intention of the user to use the restaurant by the same method as that in the first embodiment.

FIG. 18 is a diagram showing a process in which the number of points to be acquired increases by movement of the user. As shown in FIG. 18, the user searches for restaurants in the restaurant search site and selects, for example, a restaurant D from the search result. At this time, information of the restaurant D is displayed on the screen of the user terminal 3. The restaurant search server 1 temporarily determines, for example, 100 points as the number of points to be acquired of the restaurant D. Therefore, “100 points” is displayed on the screen of the user terminal 3 as the number of points to be acquired. Thereafter, the user moves and thereby is farther from the restaurant D. At this time, the number of points to be acquired increases by, for example, 50 points. Then, “150 points” is displayed on the screen of the user terminal 3 as the number of points to be acquired. Thereafter, the user moves and approaches the restaurant D. At this time, the number of points to be acquired does not change. Thereafter, the user moves and thereby is farther from the restaurant D. At this time, the number of points to be acquired increases by, for example, 100 points and “250 points” is displayed on the screen of the user terminal 3 as the number of points to be acquired. Thereafter, if the user comes to the restaurant D, the user gets 250 points. Each restaurant may be able to set whether or not to allow such an increase of the number of points to be acquired.

It is desirable that the user terminal 3 can notify the user that the number of points to be acquired has increased at any time as described above. Therefore, for example, a dedicated application for searching for restaurants in the restaurant search site is installed in the user terminal 3. When the user terminal 3 executes the dedicated application, the user terminal 3 can display the same information as that displayed in the top page, the search result page, the restaurant page, and the like in the restaurant search server 1 on the screen according to an operation of the user. The dedicated application is, for example, a resident application. It is possible to download the dedicated application from, for example, the restaurant search server 1. The user terminal 3 periodically transmits the current position of the user terminal 3 to the restaurant search server 1 and receives the updated number of points to be acquired from the restaurant search server 1. The user terminal 3 notifies the user of the updated number of points to be acquired by, for example, displaying the updated number of points to be acquired in a pop-up window or the like on the screen or vibrating the user terminal 3 by a vibration function. It is troublesome for the user if the user terminal 3 notifies the user of the updated number of points to be acquired every time the number of points to be acquired increases for all the found restaurants. Therefore, the application may be programmed so that the user terminal 3 performs the notification only for restaurants selected by the user from the screen on which the search result is displayed.

A browser can do the same thing as described above. For example, the user selects any one of the restaurants from the search result page and causes the restaurant page to be displayed. On the restaurant page, the number of points to be acquired is displayed along with the information of the restaurant. For example, the user terminal 3 performs the same process as that performed by the dedicated application on the basis of a script described in an HTML document of the restaurant page. The user terminal 3 can perform the notification to the user unless the user ends the browser.

In the present embodiment, it need not be possible to reserve a restaurant in the restaurant search site. Therefore, the reservation information DB 12d is not required. The restaurant search server 1 may also determine to give the privilege to the user when the user uses a restaurant found by the strict search. The restaurant search server 1 need not be configured to be able to perform the flexible search and the crampedness search.

FIG. 19 is a flowchart showing an example of a restaurant information transmission process of the system control unit 14 of the restaurant search server 1 according to the present embodiment. When the user specifies search conditions for searching for restaurants, the user terminal 3 transmits a search request to the restaurant search server 1. The search request includes, for example, the search conditions, the user ID of the user who uses the user terminal 3, and position information indicating the current position of the user terminal 3. The restaurant search server 1 searches for restaurants by the search process and transmits information indicating the search result (or the search result page) to the user terminal 3. The restaurant search server 1 stores the user ID and the position information stored in the search request in the RAM 14c in association with each other. The user terminal 3 displays the information indicating the search result on the screen. The user selects any one of restaurants from the screen. Then, the user terminal 3 transmits a restaurant information request to the restaurant search server 1. The restaurant information request includes, for example, the user ID and the restaurant ID of the selected restaurant. The restaurant information transmission process is started when the restaurant search server 1 receives the restaurant information request.

As shown in FIG. 19, the search result presentation unit 145 transmits information (or the restaurant page) of the restaurant indicated by the restaurant ID stored in the restaurant information request to the user terminal 3 (step S141). At this time, the search result presentation unit 145 causes the number of points to be acquired, which is calculated in the point calculation process when the restaurant indicated by the restaurant ID is found in the search process, to be included in the information of the restaurant. The search result presentation unit 145 causes the user terminal 3 to present the number of points to be acquired to the user by transmitting the information of the restaurant. Next, the point processing unit 144 acquires the position information corresponding to the user ID stored in the restaurant information request from the RAM 14c (step S142). Next, the point processing unit 144 calculates a distance from the user terminal 3 to the restaurant indicated by the restaurant ID on the basis of the acquired position information (step S143). Next, the point processing unit 144 stores the user ID and the restaurant ID stored in the restaurant information request, the number of points to be acquired, and the calculated distance in the RAM 14c in association with each other (step S144). Then, the point processing unit 144 ends the restaurant information transmission process.

Thereafter, the user terminal 3 periodically transmits a position notification message to the restaurant search server 1. The position notification message includes the user ID of the user who uses the user terminal 3, the restaurant ID of the restaurant selected by the user, and the position information indicating the current position of the user terminal 3.

FIG. 20 is a flowchart showing an example of a point control process of the system control unit 14 of the restaurant search server 1 according to the present embodiment. The point control process is started every time the restaurant search server 1 receives the position notification message.

As shown in FIG. 20, the point processing unit 144 acquires the user ID, the restaurant ID, and the position information from the position notification message (step S151). Next, the point processing unit 144 acquires the number of points to be acquired and the distance corresponding to the user ID and the restaurant ID from the RAM 14c (step S152). Next, the point processing unit 144 calculates a distance from the user terminal 3 to the position information of the restaurant indicated by the restaurant ID on the basis of the acquired position information (step S153). Next, the point processing unit 144 determines whether or not the calculated distance is smaller than or equal to a predetermined value (step S154). At this time, if the point processing unit 144 determines that the calculated distance is smaller than or equal to the predetermined value (step S154: YES), the point processing unit 144 proceeds to step S161. On the other hand, if the point processing unit 144 determines that the calculated distance is larger than the predetermined value (step S154: NO), the point processing unit 144 proceeds to step S155.

In step S155, the point processing unit 144 calculates a distance difference by subtracting the distance acquired from the RAM 14c from the distance calculated this time. Next, the point processing unit 144 determines whether or not the distance difference is larger than 0 (step S156). At this time, if the point processing unit 144 determines that the distance difference is larger than 0 (step S156: YES), the point processing unit 144 proceeds to step S158. On the other hand, if the point processing unit 144 determines that the distance difference is smaller than or equal to 0 (step S156: NO), the point processing unit 144 proceeds to step S157. In step S157, the point processing unit 144 rewrites the distance stored in the RAM 14c corresponding to the user ID and the restaurant ID into a new distance. Then, the point processing unit 144 ends the point control process.

In step S158, the point processing unit 144 determines the number of points to be added. For example, the point processing unit 144 determines the number of points so that the larger the distance difference, the larger the number of points. Then, the point processing unit 144 adds the determined number of points to the number of points to be acquired. Next, the point processing unit 144 rewrites the number of points to be acquired and the distance stored in the RAM 14c corresponding to the user ID and the restaurant ID into a new number of points to be acquired and a new distance (step S159). Next, the point processing unit 144 transmits the new number of points to be acquired to the user terminal 3 that has transmitted the position notification request (step S160). Then, the point processing unit 144 ends the point control process. The user terminal 3 that receives the number of points to be acquired displays the received number of points to be acquired on the screen. The point processing unit 144 causes the user terminal 3 to present the number of points to be acquired to the user by transmitting the number of points to be acquired.

In step S161, the point processing unit 144 provides the points to the user. Specifically, the point processing unit 144 adds the number of points to be acquired that is acquired from the RAM 14c to the number of held points corresponding to the user ID in the member information DB 12a. Then, the point processing unit 144 ends the point control process.

The fourth embodiment is the same as the first to the third embodiments except for the points described above. As described above, according to the present embodiment, the system control unit 14 temporarily determines the value of the privilege to be given to the user when a restaurant is found, causes the determined value to be presented, acquires the position information from the user terminal 3, increases the value of the privilege when it is determined that the user moves farther away from the found restaurant on the basis of the acquired position information after the restaurant is found, presents the increased value of the privilege, and determines the value of the privilege to be given to the user when the intention of the user to use the found restaurant is confirmed. Therefore, the value of the privilege increases when user does not intend to use the found restaurant and the user moves farther away from the restaurant, so that it is possible to prompt the user to change his or her mind and use the restaurant.

In the embodiments described above, the establishment of the present invention is applied to a restaurant and the present invention is applied to searching for restaurants. However, the present invention may be applied to searching for establishments other than restaurants. For example, the present invention can be applied to an establishment which includes facilities that are occupied by users and in which the facilities may be able to be occupied by the number of persons larger than the number of vacancies which is counted in units of using-persons in the facilities. Examples of such an establishment include a karaoke box and a hotel. In the case of a karaoke box, the facilities that are occupied by users of the karaoke box is, for example, chairs. For example, the fixed seating capacity of a karaoke room is determined by the number and the type of chairs (sofas) arranged in the karaoke room. In the case of a hotel, the facilities that are occupied by users of the hotel, for example, beds and futons. The number of vacancies, which is counted in units of users, of a single bed is one. The number of vacancies, which is counted in units of users, of a double bed is two. The number of vacancies, which is counted in units of users, of a one-person futon is one. For example, the capacity of a guest room is determined by the number and the type of beds arranged in the guest room or determined by the number of futons prepared in the guest room. In a hotel, for example, extra beds or futons are temporarily added, so that customers more than a fixed capacity of the guest room may be able to stay overnight.

In the embodiments described above, the information processing apparatus of the present invention is applied to a server device in a client-server system. However, the information processing apparatus of the present invention may be applied to an information processing apparatus other than the server device. For example, the information processing apparatus of the present invention may be applied to the user terminal 3 or the like. For example, a control unit included in the information processing apparatus functions as means in the present invention, and thereby the control unit may cause a display means such as a display to present the search result according to the present invention. In this case, the display means may be included in the information processing apparatus. Or, the display means may be a device separate from the information processing apparatus.

### REFERENCE SIGNS LIST

1 Restaurant search server
2 Restaurant terminal
3 User terminal
11 Communication unit
12 Storage unit
12a Member information DB
12b Restaurant information DB
12c Vacant seat information DB
12d Reservation information DB
12e Acceptable person number DB
Input/output interface
System control unit
14a CPU
14b ROM
14c RAM
15 System bus
141 Search request acquisition unit
142 Strict search unit
143 Crampedness search unit
144 Point processing unit
145 Search result presentation unit
146 Reservation processing unit
   147 Acceptable persons number estimation unit
NW Network
S Information processing system

1. An information processing apparatus comprising:
a person number acquisition means that acquires a number of using-persons which is specified by a user;
a search means that, on the basis of vacancy information stored in a vacancy information storage means that stores the vacancy information indicating a number of vacancies in facilities which are occupied by persons who use an establishment, searches for establishments which can be used by persons of which the number is acquired by the person number acquisition means, the number of vacancies being counted in units of using-persons, the search means including an establishment, in the establishments which can be used, where a degree by which the number of using-persons exceeds the number of vacancies indicated by the vacancy information is smaller than or equal to a reference value; and
a presentation control means that causes the establishments found by the search means to be presented,
wherein the search means searches for establishments by using at least one of a first method which searches for establishments where the number of vacancies which is counted in units of using-persons in facilities which are occupied by persons who use the establishment is larger than or equal to the number of using-persons, and a second method which searches for establishments where the number of vacancies which is counted in units of using-persons in facilities which are occupied by persons who use the establishment is smaller than the number of using-persons and a degree by which the number of using-persons exceeds the number of vacancies indicated by the vacancy information is smaller than or equal to the reference value.

2. The information processing apparatus according to claim 1, further comprising:
a privilege determination means that determines a privilege to be given to the user on condition that an intention is confirmed, the intention being that a group of the user uses an establishment where the number of vacancies indicated by the vacancy information is smaller than the number of using-persons which is acquired by the person number acquisition means among the establishments found by the search means and a number of persons of the group is the number of using-persons.

3. The information processing apparatus according to claim 2, wherein
the larger the number of using-persons, the higher the privilege determination means raises a value of the privilege to be given.

4. The information processing apparatus according to claim 1, further comprising:
an acceptable person number acquisition means that acquires, from an acceptable person number storage means that stores an acceptable number of persons larger than the number of vacancies which is indicated by the vacancy information, the acceptable number of persons for the number of vacancies which is indicated by the vacancy information, of an establishment, stored in the vacancy information storage means, the acceptable number of persons having been specified by the establishment,
wherein, when using the second method, the search means searches for establishments where the acceptable number of persons which is acquired by the acceptable person number acquisition means is larger than or equal to the number of using-persons.

5. The information processing apparatus according to claim 1, further comprising:
an estimation means that estimates the reference value on the basis of a reservation history of an establishment, the reservation history including a number of persons who used the establishment and a number of vacancies in the facilities which were used, the number of vacancies in the facilities which were used being counted in units of using-persons and smaller than the number of using-persons,
wherein the search means includes an establishment, in the establishments which can be used, where the degree by which the number of using-persons exceeds the number of vacancies which is indicated by the vacancy information is smaller than or equal to the reference value estimated by the estimation means.

6. The information processing apparatus according to claim 1, further comprising:
an establishment-specified search method acquisition means that acquires an establishment-specified search method specified by an establishment as a method in which the establishment is searched for, the establishment-specified search method including at least one of the first method and the second method,
wherein the search means searches for establishments whose search methods acquired by the establishment-specified search method acquisition means corresponds to the search method used by the search means.

7. The information processing apparatus according to claim 1, further comprising:
a user-specified search method acquisition means that acquires a user-specified search method specified by the user, the user-specified search method including at least one of the first method and the second method,
wherein the search means searches for establishments by using the user-specified search method acquired by the user-specified search method acquisition means.

8. The information processing apparatus according to claim 2, wherein
the privilege determination means determines the value of the privilege, which is to be given to the user, at a time when an establishment is found by the search means, and
the information processing apparatus further includes
a first value presentation control means that causes the value determined by the privilege determination means to be presented,
a position acquisition means that acquires a position of the user,
a value control means that, when it is determined on the basis of the position acquired by the position acquisition means that the user moves farther away from the establishment found by the search means, raises the value of the privilege determined by the privilege determination means, and
a second value presentation control means that causes the value of the privilege which has been raised by the value control means to be presented.

9. An information processing method performed by a computer, the method comprising:
a person number acquisition step of acquiring a number of using-persons which is specified by a user;
a search step of, on the basis of vacancy information stored in a vacancy information storage means that stores the vacancy information indicating a number of vacancies in facilities which are occupied by persons who use an establishment, searching for establishments which can be used by persons of which the number is acquired in the person number acquisition step and including an establishment, in the establishments which can be used, where a degree by which the number of using-persons exceeds the number of vacancies indicated by the vacancy information is smaller than or equal to a reference value, the number of vacancies being counted in units of using-persons; and
a presentation control step of causing the establishments found in the search step to be presented,
wherein, in the search step, establishments are searched for by using at least one of a first method which searches for establishments where the number of vacancies which is counted in units of using-persons in facilities which are occupied by persons who use the establishment is larger than or equal to the number of using-persons, and a second method which searches for establishments where the number of vacancies which is counted in units of using-persons in facilities which are occupied by persons who use the establishment is smaller than the number of using-persons and a degree by which the number of using-persons exceeds the number of vacancies indicated by the vacancy information is smaller than or equal to the reference value.

10. A non-transitory recording medium in which an information processing program is computer-readably recorded, the information processing program causing a computer to function as:
a person number acquisition means that acquires a number of using-persons which is specified by a user;
a search means that, on the basis of vacancy information stored in a vacancy information storage means that stores the vacancy information indicating a number of vacancies in facilities which are occupied by persons who use an establishment, searches for establishments which can be used by persons of which the number is acquired by the person number acquisition means, the number of vacancies being counted in units of using-persons, the search means including an establishment, in the establishments which can be used, where a degree by which the number of using-persons exceeds the number of vacancies indicated by the vacancy information is smaller than or equal to a reference value; and
a presentation control means that causes the establishments found by the search means to be presented,
wherein the search means searches for establishments by using at least one of a first method which searches for establishments where the number of vacancies which is counted in units of using-persons in facilities which are occupied by persons who use the establishment is larger than or equal to the number of using-persons, and a second method which searches for establishments where the number of vacancies which is counted in units of using-persons in facilities which are occupied by persons who use the establishment is smaller than the number of using-persons and a degree by which the number of using-persons exceeds the number of vacancies indicated by the vacancy information is smaller than or equal to the reference value.

11. The information processing apparatus according to claim 2, further comprising:
an acceptable person number acquisition means that acquires, from an acceptable person number storage means that stores an acceptable number of persons larger than the number of vacancies which is indicated by the vacancy information, the acceptable number of persons for the number of vacancies which is indicated by the vacancy information, of an establishment, stored in the vacancy information storage means, the acceptable number of persons having been specified by the establishment,
wherein, when using the second method, the search means searches for establishments where the acceptable number of persons which is acquired by the acceptable person number acquisition means is larger than or equal to the number of using-persons.

12. The information processing apparatus according to claim 3, further comprising:
an acceptable person number acquisition means that acquires, from an acceptable person number storage means that stores an acceptable number of persons larger than the number of vacancies which is indicated by the vacancy information, the acceptable number of persons for the number of vacancies which is indicated by the vacancy information, of an establishment, stored in the vacancy information storage means, the acceptable number of persons having been specified by the establishment,
wherein, when using the second method, the search means searches for establishments where the acceptable number of persons which is acquired by the acceptable person number acquisition means is larger than or equal to the number of using-persons.

13. The information processing apparatus according to claim 2, further comprising:
an estimation means that estimates the reference value on the basis of a reservation history of an establishment, the reservation history including a number of persons who used the establishment and a number of vacancies in the facilities which were used, the number of vacancies in the facilities which were used being counted in units of using-persons and smaller than the number of using-persons,
wherein the search means includes an establishment, in the establishments which can be used, where the degree by which the number of using-persons exceeds the number of vacancies which is indicated by the vacancy information is smaller than or equal to the reference value estimated by the estimation means.

14. The information processing apparatus according to claim 3, further comprising:
an estimation means that estimates the reference value on the basis of a reservation history of an establishment, the reservation history including a number of persons who used the establishment and a number of vacancies in the facilities which were used, the number of vacancies in the facilities which were used being counted in units of using-persons and smaller than the number of using-persons,
wherein the search means includes an establishment, in the establishments which can be used, where the degree by which the number of using-persons exceeds the number of vacancies which is indicated by the vacancy information is smaller than or equal to the reference value estimated by the estimation means.

15. The information processing apparatus according to claim 2, further comprising:
an establishment-specified search method acquisition means that acquires an establishment-specified search method specified by an establishment as a method in which the establishment is searched for, the establishment-specified search method including at least one of the first method and the second method,
wherein the search means searches for establishments whose search methods acquired by the establishment-specified search method acquisition means corresponds to the search method used by the search means.

16. The information processing apparatus according to claim 3, further comprising:
an establishment-specified search method acquisition means that acquires an establishment-specified search method specified by an establishment as a method in which the establishment is searched for, the establishment-specified search method including at least one of the first method and the second method,
wherein the search means searches for establishments whose search methods acquired by the establishment-specified search method acquisition means corresponds to the search method used by the search means.

17. The information processing apparatus according to claim 2, further comprising:
a user-specified search method acquisition means that acquires a user-specified search method specified by the user, the user-specified search method including at least one of the first method and the second method,
wherein the search means searches for establishments by using the user-specified search method acquired by the user-specified search method acquisition means.

18. The information processing apparatus according to claim 3, further comprising:
a user-specified search method acquisition means that acquires a user-specified search method specified by the user, the user-specified search method including at least one of the first method and the second method,
wherein the search means searches for establishments by using the user-specified search method acquired by the user-specified search method acquisition means.

19. The information processing apparatus according to claim 3, wherein
the privilege determination means determines the value of the privilege, which is to be given to the user, at a time when an establishment is found by the search means, and
the information processing apparatus further includes
a first value presentation control means that causes the value determined by the privilege determination means to be presented,
a position acquisition means that acquires a position of the user,
a value control means that, when it is determined on the basis of the position acquired by the position acquisition means that the user moves farther away from the establishment found by the search means, raises the value of the privilege determined by the privilege determination means, and
a second value presentation control means that causes the value of the privilege which has been raised by the value control means to be presented.
